(19) United States
(12) Patent Application Publication
(10) Pub. No.: US 2025/0392477 A1
(43) Pub. Date: Dec. 25, 2025

(54) DATA PROCESSING METHOD, COMPUTER DEVICE, AND STORAGE MEDIUM

(71) Applicant: TENCENT TECHNOLOGY (SHENZHEN) COMPANY LIMITED, Shenzhen (CN)

(72) Inventor: Guanghong LU, Shenzhen (CN)

(21) Appl. No.: 19/315,838

(22) Filed: Sep. 1, 2025

Related U.S. Application Data
(63) Continuation of application No. PCT/CN2023/137307, filed on Dec. 8, 2023.

(30) Foreign Application Priority Data
Jun. 29, 2023 (CN) 202310785769.8

(51) Int. Cl. H04L 9/32; H04L 9/00; H04L 9/06; H04L 9/08

(52) U.S. Cl. CPC H04L 9/3247; H04L 9/0643; H04L 9/0869; H04L 9/3268; H04L 9/50

(57) ABSTRACT

A data processing method performed on a verification node and including obtaining task event information and a signature for the task event information from a scheduling node. The task event information includes a first computing node set participating in execution of a computing task and a random seed provided by a task submission end of the computing task. The method further includes performing verification on the signature, deriving a random number set based on the random seed in response to the verification of the signature succeeds, selecting, for the computing task, a second computing node set associated with the random number set, verifying validity of the first computing node set by using the second computing node set, to obtain a verification result, and adding a block including the verification result to a blockchain of a verification node cluster including the verification node.

### CROSS-REFERENCE TO RELATED APPLICATIONS

This application is a continuation of International Application No. PCT/CN2023/137307, filed on Dec. 8, 2023, which claims priority to Chinese Patent Application No. 202310785769.8, filed with the China National Intellectual Property Administration on Jun. 29, 2023 and entitled “BLOCKCHAIN-BASED MULTI-PARTY COMPUTATION VERIFICATION METHOD AND APPARATUS, DEVICE, AND STORAGE MEDIUM,” the entire contents of both of which are incorporated herein by reference.

### FIELD OF THE TECHNOLOGY

This application relates to the field of computer technologies, and in particular, to the field of multi-party computation technologies, and provides a data processing method, a computer device, and a storage medium.

### BACKGROUND OF THE DISCLOSURE

Currently, a computing task is usually executed by using a clustering system method, but the clustering system faces a problem of confidence between cluster nodes in the system. In other words, a task initiator cannot ensure whether a computing process and a computing result are trustworthy. With the introduction of blockchain technologies, more and more blockchain-based clustering system solutions have been proposed. The blockchain is a chain data structure, and has two big features of decentralization and difficulty in tampering with data. Based on these two features, information recorded by the blockchain is more authentic and reliable. When a block is generated, it may be considered that a plurality of parties maintain a trust relationship because a plurality of cluster nodes reach a consensus. As a result, the blockchain may be configured for helping solve the problem that nodes in the system are not trusted that nodes in the system are not trusted.

However, in a current blockchain-based clustering system, the cluster nodes not only need to bear a computing task, but also need to bear a consensus task and a storage task that are related to the blockchain. As the scale of the clustering system increases, time consumption of a consensus process continuously increases, which limits the scale of the system, thereby causing computing resources provided by an entire system to be extremely limited.

### SUMMARY

In accordance with the disclosure, there is provided a data processing method, performed on a verification node in a verification node cluster of a computing system and including obtaining task event information and a signature for the task event information from a scheduling node in a scheduling node cluster of the computing system. The task event information includes a first computing node set participating in execution of a computing task and a random seed provided by a task submission end of the computing task. The method further includes performing verification on the signature, deriving a random number set based on the random seed in response to the verification of the signature succeeds, selecting, for the computing task, a second computing node set associated with the random number set from a computing node cluster of the computing system, verifying validity of the first computing node set by using the second computing node set, to obtain a verification result, and adding a block including the verification result to a blockchain of the verification node cluster.

Also in accordance with the disclosure, there is provided a data processing method, performed on a scheduling node in a scheduling node cluster of a computing system and including receiving a computing request transmitted by a task submission end. The computing request includes a computing task and a random seed provided for the computing task. The method further includes deriving a random number set based on the random seed, selecting, for the computing task, a computing node set associated with the random number set from a computing node cluster of the computing system, dispatching the computing task to the computing node set, so that the computing node set executes the computing task, updating the computing task to a completed state in response to receiving a computing result of each computing node in the computing node set for the computing task, generating task event information including the computing node set and the random seed, and a signature for the task event information, and transmitting the task event information and the signature for the task event information to a verification node, connected to the scheduling node, in a verification node cluster of the computing system, so that the verification node verifies validity of the computing node set.

Also in accordance with the disclosure, there is provided a data processing method, performed on a computing node in a computing node cluster of a computing system and including receiving a computing request transmitted by a scheduling node connected to the computing node. The computing request instructs to execute a computing task submitted by a task submission end. The method further includes executing the computing task to obtain a computing result, signing the computing result based on a digital certificate of the computing task to obtain signature information, and transmitting the computing result and the signature information to the scheduling node, to cause the scheduling node to update the computing task to a completed state in response to a computing result for the computing task by each computing node in a computing node set participating in the execution of the computing task is received, generate task event information including the computing node set and a random seed provided by the task submission end, and a signature for the task event information, and transmit the task event information and the signature for the task event information to a verification node, connected to the scheduling node, in a verification node cluster of the computing system, so that the verification node verifies validity of the computing node set.

### BRIEF DESCRIPTION OF THE DRAWINGS

To describe technical solutions in embodiments of this application more clearly, the accompanying drawings needed for describing the embodiments are to be briefly described below. Apparently, the accompanying drawings in the following description merely show some embodiments of this application, and a person of ordinary skill in the art may still derive other accompanying drawings based on the provided accompanying drawings without creative efforts.

FIG. 1 is a schematic structural diagram of a blockchain according to an embodiment of this application.

FIG. 2 is a schematic diagram showing an application scenario according to an embodiment of this application.

FIG. 3A and FIG. 3B are schematic architectural diagrams of a computing system according to an embodiment of this application.

FIG. 4A to FIG. 4C are schematic structural diagrams of each node according to an embodiment of this application.

FIG. 5 is a schematic flowchart of a scheduling node deployment process according to an embodiment of this application.

FIG. 6A and FIG. 6B are schematic diagrams of a deployment page of a scheduling node according to an embodiment of this application.

FIG. 7 is a schematic flowchart of a computing node deployment process according to an embodiment of this application.

FIG. 8 is a schematic flowchart of a data processing method according to an embodiment of this application.

FIG. 9A and FIG. 9B are schematic diagrams of a related page according to an embodiment of this application.

FIG. 10 is a schematic flowchart of a random selection process according to an embodiment of this application.

FIG. 11 is a schematic flowchart of a computing task scheduling and allocation process according to an embodiment of this application.

FIG. 12 is a schematic flowchart of a computing task scheduling and allocation process according to an embodiment of this application.

FIG. 13 is a schematic structural diagram of a data processing apparatus according to an embodiment of this application.

FIG. 14 is a schematic structural diagram of another data processing apparatus according to an embodiment of this application.

FIG. 15 is a schematic structural diagram of still another data processing apparatus according to an embodiment of this application.

FIG. 16 is a schematic structural diagram showing composition of a computer device according to an embodiment of this application.

### DESCRIPTION OF EMBODIMENTS

To make objectives, technical solutions, and advantages of this application clearer and more understandable, the technical solutions in embodiments of this application are to be clearly and completely described below with reference to the accompanying drawings in the embodiments of this application. Apparently, the embodiments to be described are merely a part rather than all of the embodiments of this application. All other embodiments obtained by a person of ordinary skill in the art based on the embodiments of this application without creative efforts fall within the protection scope of this application. The embodiments in this application and features in the embodiments may be combined in different manners to form other embodiments in a case that no conflict occurs. In addition, although a logical order is shown in a flowchart, in some cases, the operations shown or described may be performed in an order different from that herein.

If a specific implementation of this application below relates to relevant data of a target object, a relevant permission or consent needs to be obtained when the embodiments of this application are applied to a specific product or technology. Collection, use, and processing of the relevant data need to comply with relevant laws, regulations, and standards of relevant countries and regions.

For ease of understanding of the technical solutions provided in the embodiments of this application, key nouns used in the embodiments of this application are first described herein.

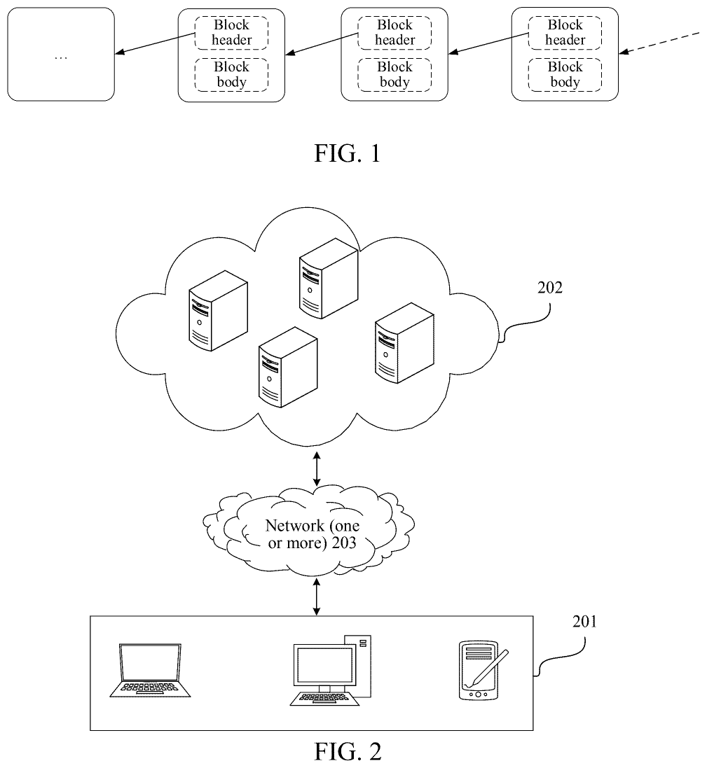

Blockchain: It is also referred to as a distributed data record ledger, is a chain data structure which combines data blocks in a sequentially connected manner in a chronological order, and is a decentralized distributed ledger cryptographically guaranteed to be tamper-proof and unforgeable. The blockchain is generally composed of contents such as a consensus, blocks, state data storage, and cryptographic identity security. Since the ledger is stored in a distributed manner and blocks are obtained through consensus, the blockchain has characteristics such as tamper resistance, traceability, and common maintenance. FIG. 1 is a schematic structural diagram of a blockchain according to an embodiment of this application. A blockchain is formed by serially connecting blocks.

The block is configured for recording a data set and a state result divided based on a specific condition, and is formed after nodes reach a consensus. In this embodiment of this application, data that needs to be recorded is mainly a validity verification result randomly allocated to computing nodes. Specifically, the blocks may be divided based on time. For example, if a block is generated at an interval of 10 seconds (s), the block records all data in the 10 s. Alternatively, the blocks may also be divided based on a quantity of computing tasks. For example, if a block is generated after a specified quantity of computing tasks are received, the block is configured for recording the validity verification results corresponding to the received specified quantity of the computing tasks. Certainly, a specific division manner of the blocks is not limited in this embodiment of this application. Referring to FIG. 1, a rectangular solid-line frame represents a block, and a block may generally include a block header and a block body. The block header includes a previous block address (Prev-block). The previous block address may be generally stored in the block header in a form of a previous block hash code (pre-hash). All blocks are connected in series by pointing to the previous block address, to form a blockchain. The block body is configured for storing specific data, for example, the validity verification results in this embodiment of this application.

Blockchain network: A blockchain network is composed of a plurality of distributed devices. In blockchain technologies, any device in a network may be used as a node of the blockchain and may participate in recording and storing the blockchain. Based on a consensus mechanism, nodes jointly maintain an entire blockchain through competitive computing. Any node may have a complete copy of data of the blockchain. Therefore, if any node becomes invalid, the remaining nodes can still work normally. As a result, a blockchain-based storage manner has high reliability.

In addition, in the blockchain technologies, a large number of nodes are configured to jointly maintain the entire blockchain, and permissions owned by the nodes may be the same. Therefore, a centralized device or a management organization does not exist. All data information in the blockchain is open and transparent. Modification of data of a single node or even a plurality of nodes cannot affect data of another node, unless more than half of nodes in an entire blockchain network can be controlled to be modified. However, this manner is excessively difficult. In addition, each block in the blockchain is associated with two previous and following blocks. To tamper with data of one block, data of a plurality of blocks related to the block needs to be tampered with. As a result, the data stored based on the blockchain is immutable.

Secure multi-party computation (SMPC): It means that in a case that a trusted third party does not exist, a plurality of participants cooperate to calculate an agreed function, and each party is ensured to obtain only a computing result of the party, and input and output data of any other party cannot be predicted through interaction data in a calculation process (unless a function may predict input and output of another party through the input of the function).

Random seed: A seed means an initial value, and is configured for generating a pseudo-random number. Specifically, the random seed is a starting point for generating a random sequence. Generally, random numbers of a computer are pseudo-random numbers. A random seed is used as an initial condition, and then, a specific algorithm is configured for continuously iteratively generating a random number.

Signature and signature verification: A signature is also referred to as a digital signature or a public key digital signature, and is a digital string that can only be generated by a transmitter of information and cannot be forged by others. The digital string is also an effective proof of authenticity of the information transmitted by the transmitter of information. Signature verification is to verify validity of a signature, and a receiving party needs to confirm whether a file received by the receiving party is really transmitted by a transmitting party, and needs to confirm that the file has been tampered with or not. Signature verification is finally compared based on a message digest.

Digital certificate: It is referred to as a certificate for short, which is an electronic file that uniquely identifies a person and a resource on a network. The certificate enables two entities to communicate safely and confidentially. A plurality of types of certificates exist, for example, a personal certificate (used by an individual) and a server certificate (configured to establish a secure session between a server and a client through a secure sockets layer (SSL) technology). Generally, the digital certificate is issued by a trusted institution or by a trusted person in an organization.

Load balancing: It is a method for evenly distributing network traffic in a resource pool supporting an application. Generally, a current application needs to simultaneously process millions of users, and return correct text, videos, images, and other data to each user in a quick and reliable manner. To process such a high traffic, most applications have a plurality of resource servers, which contain a plurality of repeated data. A load balancer is a device located between a user and a server group, and serves as an invisible coordinator, to ensure equal use of all resource servers.

Process: It is a running activity of a program on a data set in a computer, is a basic unit for a system to perform resource allocation, and a basis of an operating system structure. In an early computer structure designed oriented to a process, a process is a basic executing entity of a program. In a current thread-oriented computer structure, a process is a container of a thread. A program is a description of an instruction, data, and an organization form thereof, and a process is an entity of the program.

Coroutine: It is not a system-level thread. In a plurality of cases, the coroutine is referred to as a “lightweight thread,” a “micro-thread,” a “fiber,” or the like. Simply put, the coroutine may be considered as a function in a thread. In other words, different coroutines may be different functions in a thread. In other words, a thread may include a plurality of coroutines. These functions can be quickly switched to each other. The coroutine is very similar to a user-state thread. Switching between user-state threads does not need to be stuck in a kernel, but switching between user-state threads in some operating systems needs to be assisted by a kernel-state thread.

A technical idea of the embodiments of this application is briefly described below.

In the related art, the blockchain solves a problem that nodes in a clustering system are not trusted with each other. However, a new problem is consequently caused. In other words, a conventional blockchain node needs to simultaneously bear a consensus and a storage task related to the blockchain, and further needs to bear a computing task of a cluster. Therefore, when a scale of the cluster is continuously expanded, time consumption of consensus processes of a large number of nodes is continuously increased, so that an increase in the scale of the system is restricted.

Therefore, in the related art, an external computing service party is specified in the intelligent contract of the blockchain, and a cluster node no longer bears a computing task. However, in this solution, the cluster node creates a block when receiving a computing task. The cluster node needs to wait for the external computing serving party to return a computing result of each computing task in the block before a consensus on the computing result is reached in the block. After the consensus passes, the block can be uploaded to and a next block can be created. A computing process generally consumes a relatively long time. Therefore, a block generation speed of the blockchain is slow, and efficiency of the system is not high.

In consideration of the restriction caused by a blockchain system architecture in the related art, to improve a case in which a computing capability is difficult to be extended, the blockchain system architecture needs to be improved. Therefore, an embodiment of this application provides a computing system supporting node expansion. The computing system includes a verification node cluster, a scheduling node cluster, and a computing node cluster, which are respectively configured to undertake a blockchain consensus, computing scheduling, and computing processes related to multi-party computing. In this way, in this embodiment of this application, tasks related to multi-party computing may be decoupled, which causes a node to be easily expanded. For example, a scheduling node and a computing node may be flexibly extended based on a need, without considering a problem of low system efficiency caused by increasing time consumption of a consensus process due to adding the node, thereby improving scalability of the computing resource of the computing system. In an actual scenario, a user may even add a personal computer to the computing node cluster, to provide a computing capability, so that computing resource can be randomly extended.

An embodiment of this application provides a data processing method based on the foregoing system architecture. In the method, when a computing task is submitted, a task submission end submits a random seed. When scheduling the computing task submitted by the task submission end, a scheduling node selects, based on a second random number set derived from the random seed, a first computing node set executing the computing task. After the computing nodes finish executing the computing task, task event information and a signature for the task event information are generated. The task event information includes the first computing node set participating in executing the computing task and the random seed provided by the task submission end of the computing task. Therefore, when performing block producing through a consensus, the verification node may determine a second computing node set based on the random seed after the signature is verified, so as to verify validity of the first computing node set actually participating in executing the computing task based on the second computing node set. Therefore, in this embodiment of this application, the computing node is randomly selected based on the random seed transmitted by the task submission end, thereby ensuring fairness and security of the computing task. Moreover, in this embodiment of this application, consensus verification is performed on the computing node set selected through the random seed, thereby resolving a problem of system credibility through a feature of the blockchain. In addition, because the verification node does not need to perform consensus verification on a computing result, but uses a manner of verifying whether allocation of the verification node is valid, fewer computing resources are needed for the verification node to obtain a block, thereby reducing a block producing blockage of the blockchain, and improving block generation efficiency of the blockchain.

In the embodiments of this application, with reference to the foregoing system architecture, infinite scalability of multi-party computing can further be provided. Each user may access a computer thereof to a nearest scheduling node, which is used as a computing node to provide certain computing power. In addition, a plurality of authentication mechanisms based on a plurality of architectural blockchains are further provided. A manner of issuing certificates level by level ensures legal authority of a node, and enables a user to perform trusted verification on an identity of the node.

Application scenarios to which the technical solutions of the embodiments of this application can be applied are briefly described below. The application scenarios described below are merely configured for describing this embodiment of this application but are not intended to limit this application. In a specific implementation process, the technical solutions provided in the embodiments of this application may be flexibly used based on an actual need.

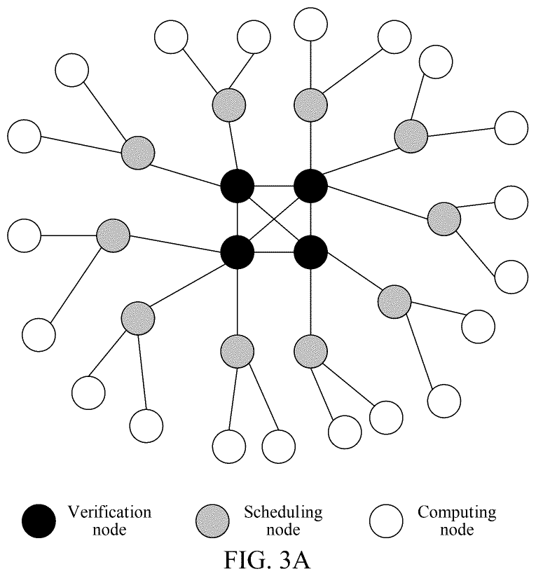

The solutions provided in the embodiments of this application may be applicable to most scenarios involving computing, for example, applicable to a big data computing scenario or a cloud computing scenario. FIG. 2 is a schematic diagram showing an application scenario according to an embodiment of this application. In the scenario, a terminal device 201 and a computing system 202 may be included.

The terminal device 201 may be, for example, any device that can submit a computing task, such as a mobile phone, a tablet computer (PAD), a notebook computer, a desktop computer, a smart television, a smart on-board device, or a smart wearable device. A target application may be installed on the terminal device 201, and the target application has functions of presenting and submitting a computing task. The application involved in this embodiment of this application may be a software client, or may be a client such as a web page or an applet, and a specific type of the client is not limited.

The computing system 202 is configured for providing actual task scheduling and execution, and store state data (for example, a scheduling result for each computing task) related to execution of an entire system task, to ensure credibility between nodes in the system. The computing system 202 may be a server cluster formed by a plurality of physical servers, a distributed system, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform, but is not limited thereto.

In an actual scenario, a user may submit a computing task of the user through the terminal device 201, and submit a random seed for the computing task while the computing task is submitted. The computing system 202 may randomly schedule computing nodes for the user based on the random seed, to execute the computing task through the computing nodes. However, in computer technologies, a real random number actually does not exist, and all random numbers are pseudo-random numbers. In other words, a specific law exists. Therefore, in this embodiment of this application, although a random seed is submitted together when a computing task is submitted, a random seed may essentially specify some computing nodes. In one aspect, a user may select a computing node expected by the user, and in another aspect, such a random allocation manner can ensure fairness of allocation of computing nodes in a system. In addition, scheduling of the computing nodes is actually trackable in a pseudo-random number manner, thereby providing feasibility of verifying a scheduling result.

In this embodiment of this application, the computing system 202 adopts a multi-party computing architecture based on a plurality of architecture blockchains, which is composed of three parts: a verification node cluster, a scheduling node cluster, and a computing node cluster. Each cluster bears a system function. Various functions in the system can be independently performed by using each type of cluster, which lays a foundation for scalability of the system.

In this embodiment of this application, the terminal device 201 and the computing system 202 may be in direct or indirect communication connection through one or more networks 203. The network 203 may be a wired network, or may be a wireless network. For example, the wireless network may be a mobile cellular network, or may be a wireless-fidelity (Wi-Fi) network, or certainly may be another possible network, which is not limited in this embodiment of this application.

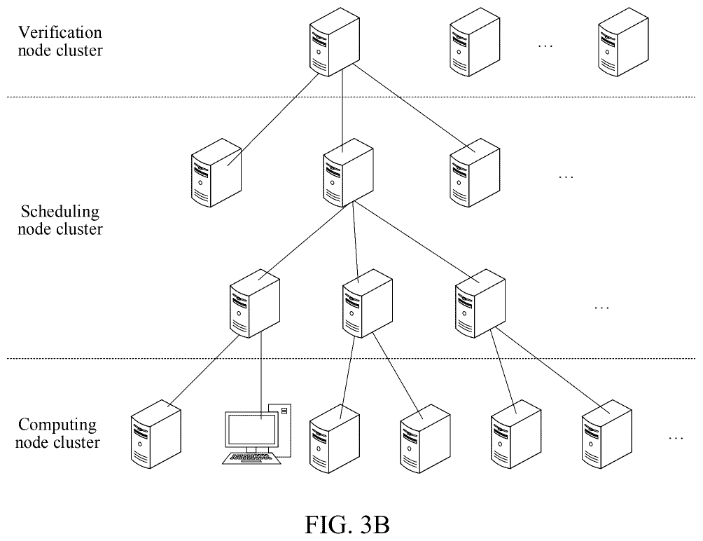

FIG. 3A is a schematic architectural diagram of a computing system 202 according to an embodiment of this application. A black circle represents a verification node, a gray circle represents a scheduling node, and a white circle represents a computing node.

As shown in FIG. 3A, the verification node cluster includes a plurality of verification nodes. The verification nodes are connected to each other. Each verification node is connected to at least one scheduling node in the scheduling node cluster, and each scheduling node is uniquely connected to a verification node. Each scheduling node in the scheduling node cluster is connected to at least one computing node in the computing node cluster, and each computing node is uniquely connected to one scheduling node.

As shown in FIG. 3A, the computing system 202 is a top-down three-level architecture. The verification node cluster is at a first level and is configured to bear a central audit task of the entire system, including a consensus verification task of a blockchain. The scheduling node cluster is at a second level and is configured to bear a scheduling task of the entire system. In other words, a computing task is scheduled to a corresponding computing node. The computing node cluster is at a third level and is configured to implement a computing function of the entire system.

In an actual scenario, to implement higher-level architecture expansion, the foregoing clusters may be substantially further layered. FIG. 3B is a schematic architectural diagram of another computing system 202 according to an embodiment of this application. Layering of a scheduling node is specifically shown herein as an example.

Similar to FIG. 3A, each verification node in the verification node cluster is connected to at least one scheduling node in the scheduling node cluster, and each scheduling node is uniquely connected to a verification node. A difference from FIG. 3A lies in that the scheduling node cluster may include a plurality of scheduling node sub-clusters, and each scheduling node sub-cluster includes N levels of scheduling nodes. A first level of scheduling node connects at least one verification node to a next level of scheduling node, a last level of scheduling node connects a corresponding computing node to a previous level of scheduling node, and an i^{th} level of scheduling node is connected to an (i−1)th level of scheduling node and an (i+1)^{th} level of scheduling node, i being a positive integer greater than 1 and less than N, N being a positive integer greater than 1.

As shown in FIG. 3B, a scheduling node connected to each verification node is a root node in a scheduling node sub-cluster. After the scheduling node, a plurality of levels of scheduling nodes may be connected. Although FIG. 3B only shows a first level of scheduling node, in an actual application, more levels of scheduling nodes may be arranged based on an actual situation, and each scheduling node may manage and schedule a computing node connected to a sub-node thereof.

It can be seen that in the architecture shown in FIG. 3B, for the computing node, a computing device of the user may be added to the computing node cluster, thereby expanding a computing capability of the entire system.

A quantity of nodes in the foregoing figure is merely an example. In an actual scenario, the quantity of nodes may be properly configured based on an actual scenario, which is not limited in this embodiment of this application. In addition, in an actual node establishment process, load balancing needs to be performed as much as possible. In other words, quantities of sub-nodes allocated to the nodes are the same as much as possible, to avoid excessively heavy load of a single node.

During actual application, a user may submit a computing task through the terminal device 201, and the computing task reaches a scheduling node in the foregoing scheduling node cluster. The scheduling node may be a node selected by the user, or may be a scheduling node allocated by a system. The scheduling node allocates a computing node to the user based on a random seed subsequently submitted by the user along with the computing task. Meanwhile, a verification node generates a corresponding random number verification task after execution of the computing task is completed, to verify validity of computing node allocation performed by the scheduling node. In other words, the verification node also determines a computing node allocated to the user based on the random seed, and is compared with the computing node allocated by the scheduling node, to determine whether scheduling is valid, thereby ensuring credibility of the nodes in the system.

The foregoing nodes are respectively described below.

### (I) Verification Node

It may be referred to as a central audit blockchain node. Each verification node is a node in a verification node cluster. The verification node mainly undertakes a task related to the blockchain, and is configured to maintain a state of the blockchain, including verifying computing results of random numbers of all scheduling nodes, and synchronizing states of all computing tasks.

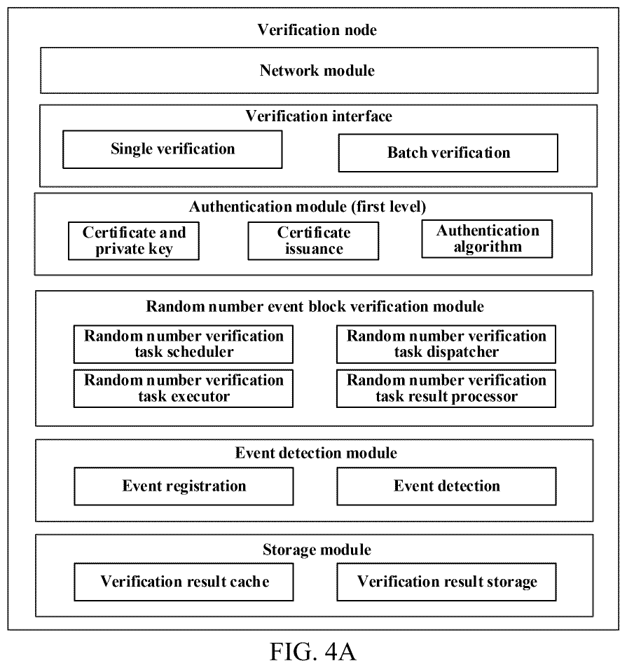

FIG. 4A is a schematic structural diagram of a verification node according to an embodiment of this application. Because each verification node has a similar structure, a description is provided by using one verification node as an example, and the verification node includes the following modules: a network module, a verification interface module, an authentication module, a random number event block verification module, an event subscription module, and a storage module.

(1) The network module is responsible for communicating with another verification node in a verification node cluster, a scheduling node, and a terminal device of a user.

(2) The verification interface module is configured for an externally provided verification interface, where the module may include a single verification interface and a batch verification interface, and may be configured to implement a single verification task and a batch verification task when being separately invoked. The single verification task may refer to that when a user or another node in a system needs to perform a single verification on a state stored in a blockchain, the single verification interface may be invoked to perform a single verification task. Alternatively, the batch verification task may refer to that when a user or another node in a system needs to perform a batch verification on a state stored in a blockchain, the batch verification interface may be invoked to perform a batch verification task.

(3) The authentication module (a first level) is configured to be responsible for functions such as verifying authority, saving a certificate, and issuing a certificate. The module includes: a certificate and a private key storage submodule, configured to store a certificate of each role in the system and a private key thereof, for example, store a certificate thereof and a certificate of a scheduling node; a certificate issuance submodule, configured to issue a certificate to a next-level scheduling node when a deployed scheduling node is newly added; and an authentication algorithm submodule, configured to store relevant cryptographic algorithms for verifying correctness of a user signature and validity of a certificate, and invoke these algorithms to implement relevant signature verification and certificate verification processes. The first level herein means that a verification node may be considered to be at a first level, and an authentication module corresponding to the verification node is correspondingly considered to be at a first level. For ease of distinguishing authentication modules of various nodes, subsequent authentication modules of other nodes are correspondingly at a second level, a third level, or the like.

(4) The random number event block verification module is configured to verify a random number task of the scheduling node, namely, verify whether the scheduling node correctly performs allocation of the computing node according to an established rule based on the random seed provided by the user. The module includes: a random number verification task scheduler, responsible for scheduling a task of random number verification; a random number verification task dispatcher, responsible for dispatching a task of random number verification; a random number verification task executor, responsible for executing a task of random number verification; and a random number verification task processor, responsible for verifying whether a random number result is correct.

(5) The event subscription module is configured to be responsible for subscribing to a target event from a scheduling node, where the target event includes an event related to a computing task, for example, computing task node allocation, computing task dispatch, and computing task completion. The module includes: an event registration submodule, responsible for registering a subscription event with a scheduling node; and an event detection submodule, responsible for detecting an event message transmitted by a scheduling node.

(6) The storage module is configured to store a verification result, so that the verification result may be directly obtained and verification calculation does not need to be repeated if an existing verification result exists next time. The module includes: a verification result cache submodule, configured to cache a verification result, namely, store the verification result in a memory; and a verification result storage submodule, configured to persistently store the verification result, for example, store the verification result in a database.

### (II) Scheduling Node

The scheduling node may be configured to be responsible for a task related to task scheduling, for example, maintain a state of each computing node, compute a node corresponding to a user based on a random seed provided by the user, and dispatch a computing task to each computing node.

FIG. 4B is a schematic structural diagram of a scheduling node according to an embodiment of this application. Because each scheduling node has a similar structure, a description is provided by using only one scheduling node as an example, and the scheduling node includes the following modules: a network module, an authentication module, an event server module, a task queue module, a load balancing module, and a storage module.

(1) The network module is configured to be responsible for communicating with a verification node, a terminal device of a user, and a computing node, including receiving a computing task submitted by the user and performing random computation to allocate a computing node for the computing task, receiving a block of another scheduler node and performing verification, communicating with a task and a state between the computing nodes, and the like.

(2) The authentication module (a second level) is configured to be responsible for storing a certificate of a computing node, and verify validity of identities of a user, a scheduling node, and a verification node. The module includes: a certificate and a private key storage submodule, configured to store a certificate of each role and a private key thereof, for example, a certificate thereof or a certificate of a computing node; a certificate issuance submodule, configured to issue a certificate to a computing node; and an authentication algorithm submodule, configured to store relevant cryptographic algorithms for verifying correctness of a user signature and validity of a certificate, and invoke these algorithms to implement relevant signature verification and certificate verification processes.

(3) The event server module is configured to be responsible for storing an event and providing a service of subscription to the event to a verification node.

(4) The task queue module is configured to be responsible for scheduling a computing task of a user. The module includes: a task verification submodule, configured to verify validity of a task before the task enters a task queue; a task queue submodule, configured to maintain all computing tasks; a priority ranking submodule, configured to rank the computing tasks based on priorities, for example, rank all computing tasks based on time consumption of the computing tasks, a conflict between tasks, or pre-configured priorities; and a task dispatch submodule, configured to dispatch the computing tasks to the computing nodes.

(5) The load balancing module is configured to be responsible for maintaining a computing node state table, performing task dispatch, and maintaining a load balancing state of the system. The module includes: a random number derivation algorithm submodule, configured to derive, based on a random seed provided by a user, an algorithm for selecting a computing node by the random number; and a node state table submodule, configured to maintain states of all nodes. For example, a table storing states of all nodes may be stored.

(6) The storage module is configured to store computing results of all the computing tasks, task data, task code, and the like. The module includes: an execution result cache submodule, configured to cache a computing result obtained by each computing node by executing a computing task, so that a result may be directly returned when the same computing task is received; and a task execution and data storage submodule, configured to cache code and data when executing a task, to avoid that a user needs to transmit code and data during each calculation.

### (III) Computing Node

The computing node is a node that actually performs computing, which may be a node deployed in a system natively, or may be a computer device added by a user. The computing nodes implement computing of a computing task based on a multi-party computation algorithm.

FIG. 4C is a schematic structural diagram of a computing node according to an embodiment of this application. Because a structure of each computing node is similar, a description is provided by using only one computing node as an example, and the computing node includes the following modules: a network module, an authentication module, a task queue module, a task execution module, and a detection module.

(1) The network module, configured to be responsible for communicating with a scheduling node, receiving a computing task dispatched from the scheduling node, returning a computing result, and sharing a computing state and a resource state thereof with the scheduling node.

(2) The authentication module (a third level) is configured to be responsible for storing a certificate of a scheduling node to verify validity of an identity of the scheduling node when receiving a message of the scheduling node. The module includes: a certificate and a private key storage submodule, configured to store a certificate of a scheduling node and a private key thereof, and an authentication algorithm submodule, configured to store relevant cryptographic algorithms for verifying correctness of a user signature and validity of a certificate, and invoke these algorithms to implement relevant signature verification and certificate verification processes.

(3) The task queue module is configured to be responsible for temporarily storing a queue of to-be-executed computing tasks (also referred to as “target computing tasks”). The module includes: a queue module, configured for saving all computing tasks; and a priority sorting submodule, configured to sort the computing tasks in the task queue based on a rule, where the rule may be, for example, sorting the computing tasks based on time consumption of the computing tasks, a conflict between tasks, or a pre-configured priority.

(4) The task execution module is an actual execution module of the computing task. The module includes: a resource scheduling submodule, configured to schedule a computing task and a process or a coroutine resource of the computing task when the computing task is executed, where the process or the coroutine is an entity that actually executes the computing task.

(5) The detection module is configured to perform information collection and state monitoring on a node resource included in the detection module, where the node resource is mainly a resource related to calculation, for example, a resource such as a memory or a central processing unit (CPU). The module may include: a node state monitoring submodule, being a module configured to detect and present a node state thereof, and a node information collection submodule, being a module configured to collect state information of the node.

Through the foregoing architecture solution, modules included in the nodes cooperate with each other, so as to ensure infinite scalability of multi-party computation. Each user may access a computer thereof to a nearest scheduling node, and provide a specific computing power as the computing node. A user needing computation may transmit a computing task to a designated scheduling node, and randomly select a computing node based on a random seed transmitted by the user, thereby ensuring fairness and security of the computing task. Finally, identities of all nodes can be ensured to be trustworthy through a plurality of certificate authority mechanisms, which may be widely reused in the industry.

In a possible implementation, all of the foregoing clusters (such as the verification node cluster, the scheduling node cluster, and the computing node cluster) may use a distributed deployment architecture, or some clusters may use a distributed deployment architecture. For example, the distributed architecture may be a blockchain architecture.

The blockchain is a new application mode of computer technologies such as distributed data storage, point-to-point transmission, a consensus mechanism, and an encryption algorithm. The blockchain, in essence, is a decentralized database, and includes a series of data blocks generated associatively through a cryptographic method. Each data block includes information about a batch of network transactions (which refer to operations in a system), which is configured to verify effectiveness (anti-counterfeiting) of the information and generate a next block. The blockchain may include an underlying blockchain platform, a platform product service layer, and an application service layer.

The underlying blockchain platform may include processing modules such as a user management module, a basic service module, a smart contract module, and an operation detection module. The user management module is responsible for identity information management of all blockchain participants, including maintenance of public/private key generation (account management), key management, maintenance of a correspondence between a real user identity and a blockchain address (authority management), and the like. In addition, when authorized, the user management module monitors and audits transactions of some certain real identities, and provides risk control rule configuration (risk control audit). The basic service module is deployed on all blockchain node devices to verify effectiveness of a business request and record the effective request in a storage after a consensus is reached on the service request. For a new business request, the basic service module first performs adaptation analysis and authentication on an interface (interface adaptation), and then encrypts business information through a consensus algorithm (consensus management), transmits the encrypted business information to a shared ledger (network communication) in a complete and consistent manner after encryption, and records and stores the encrypted business information. The smart contract module is responsible for registration, issuance, triggering, and execution of a contract. A developer may define a contract logic through a specific programming language, publish the contract logic on the blockchain (contract registration), invoke a key or another event to trigger execution based on a logic of contract terms, complete the contract logic, and provide functions of contract upgrading and canceling. The operation detection module is mainly responsible deployment, configuration modification, contract setting, and cloud adaptation during product release, and visualized output of a real-time state, such as alarm, a detected network state, and a detected node device health state during product running.

The platform product service layer provides basic capabilities and implementation frameworks for typical applications. A developer can implement a service logic on the blockchain based on the basic capabilities in combination with business characteristics. The application service layer provides application services based on blockchain solutions for business participants to use.

In this embodiment of this application, a blockchain-based computing system with a plurality of architectures is provided above. A random scheduling task is audited through the verification node cluster, to ensure credibility of random generation of the scheduling node. The computing task of the user is scheduled through the scheduling node on an intermediate layer, to share scheduling pressure, and ensure that selection of the computing node meets randomness as much as possible. In addition, based on the foregoing process, a plurality of authentication mechanisms based on a plurality of architectural blockchains are further provided. A manner of issuing certificates level by level ensures legal authority of a node, and enables a user to perform trusted verification on an identity of the node.

Through the foregoing solution, infinite scalability of the multi-party computation can be ensured. Each user may access a computer thereof to the nearest scheduling node, which is used as a computing node to provide a specific computing power. Through the plurality of certificate authority mechanisms, it can be ensured that identities of all nodes are trustworthy. The foregoing system architecture is a running basis of the entire environment, and it is ensured that the system runs efficiently and stably through the foregoing solution and the system architecture.

Based on the foregoing architecture, an embodiment of this application further provide a multi-party computation full life cycle process based on a plurality of architecture blockchains, including a scheduling node deployment process (a process of deploying a scheduling node), a computing node deployment process (a process of deploying a computing node), a computing task scheduling and distribution process (a process of performing random distribution and scheduling on a computing task), and a computing result event subscription and verification process (a process in which a central audit blockchain node performs event subscription to a computing result and verifies validity of an event). Through the design of these processes, stable and high-efficient operation of the multi-party computation full life cycle based on a plurality of architecture blockchains can be ensured.

In combination with the application scenarios and the system architecture described above, the multi-party computation full life cycle process based on a multilayer architecture blockchain provided in exemplary embodiments of this application is described below with reference to the accompanying drawings. The foregoing application scenarios are merely shown to facilitate understanding of the spirit and principle of this application, and the implementations of this application are not limited in this regard.

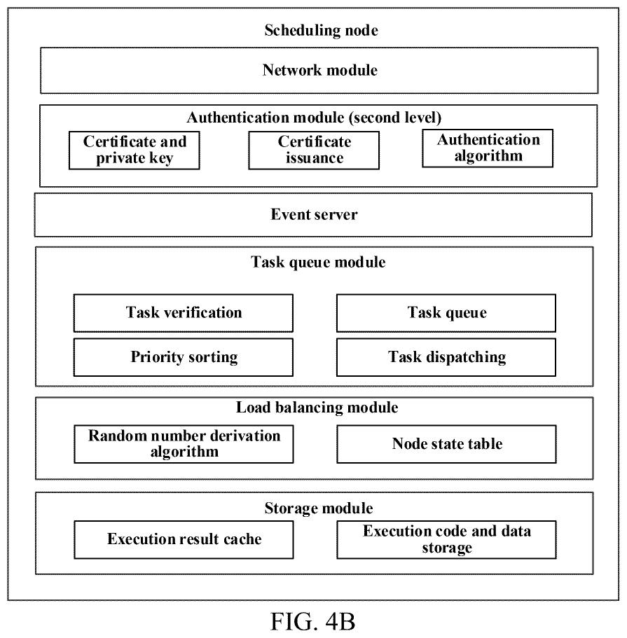

In this embodiment of this application, scheduling of the computing task is performed based on the scheduling node. Therefore, a deployment process of the scheduling node is first described herein. The deployment of the scheduling node refers to adding the scheduling node to the scheduling node cluster. FIG. 5 is a schematic flowchart of a scheduling node deployment process according to an embodiment of this application. The process includes the following operations.

Operation 501: A deployment device prepares information needed for deployment of a scheduling node.

In this embodiment of this application, when a to-be-deployed scheduling node (also referred to as a “target scheduling node”) is deployed, necessary information needed for deployment, such as public and private keys and identity information of the scheduling node, and interface information of an event notification interface, needs to be provided at a preparation stage.

In a possible implementation, the deployment device may be a terminal device of a user that initiates deployment of a scheduling node, for example, a personal computer or a tablet computer. The device is configured to initiate a deployment process for a to-be-deployed scheduling node. The terminal device may present a corresponding deployment page to the user, so that the user may add or generate information related to the to-be-deployed scheduling node in the deployment page.

In a possible implementation, the deployment device may be the to-be-deployed scheduling node. In this case, a subsequent deployment process may be initiated through the scheduling node, which is specifically shown as an example in FIG. 5. For example, related deployment software may be deployed on the scheduling node. After necessary information (for example, information such as a connected verification node or an access device address of a system) is configured, the deployment software is started to start deployment preparation work.

As shown in FIG. 5, a preparation process may include the following operations.

Operation 5011: Generate a public-private key pair of the scheduling node based on a cryptographic algorithm, where the private key is configured for encrypting a message when the scheduling node transmits the message, and the public key is public to another node, and is configured for verifying, when receiving the message transmitted by the scheduling node, whether the message has been tampered with.

Operation 5012: Add identity information of the scheduling node, which may mean adding identity information of the scheduling node in an initiated deployment request, for example, organization information to which the scheduling node belongs, and is configured for determining an organization from which the scheduling node comes.

Operation 5013: Start an event server of the scheduling node. The event server is configured to store event-related information, such as a scheduling event of a computing task, a preparation completion event of a computing task, and a computation completion event of a computing task. Although referred to as an event server, the event server may be considered as storage space of the scheduling node, and is configured to store information related to a system event and provide the information to another node for subscription. Certainly, the event server may alternatively be a server externally connected to the scheduling node, and is exclusively configured to store and notify information related to an event.

Operation 5014: Add interface information of the event notification interface of the scheduling node, which may mean adding the interface information of the event notification interface of the scheduling node in the initiated deployment request, for example, an Internet Protocol (IP) address and port information of the foregoing event server.

Certainly, the preparing node may further include another possible information, which is not limited in this embodiment of this application. In addition, the foregoing operations are not in an actual sequential order, and may be performed simultaneously or in a sequential order during actual application.

Operation 502: The deployment device transmits a scheduling node deployment request to a verification node, and the verification node receives the scheduling node deployment request.

The scheduling node deployment request may carry identity information of the to-be-deployed scheduling node and interface information of the event notification interface that are obtained at the foregoing preparation stage.

In this embodiment of this application, each scheduling node is connected to a verification node, so that the user may select a verification node of the to-be-deployed scheduling node. For example, selection may be performed based on distances, or selection may be performed based on a degree of load resource vacancy of the verification node.

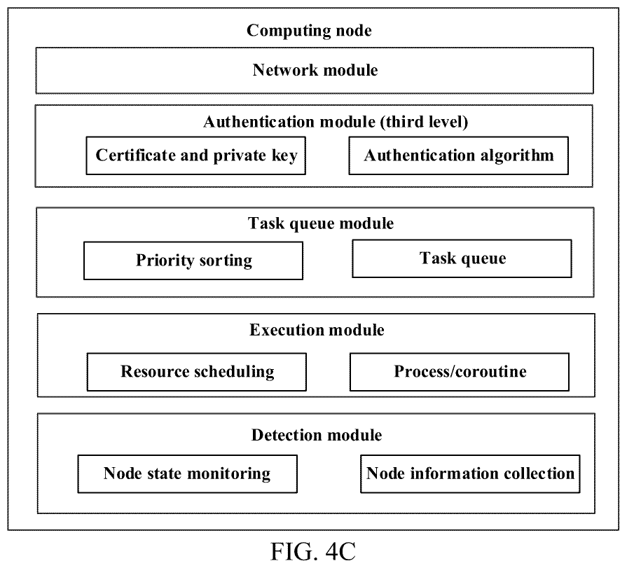

FIG. 6A and FIG. 6B are schematic diagrams of a deployment page of a scheduling node according to an embodiment of this application, where content related to selection of a verification node is shown. A user may select a verification node connected to a current verification node through the page. On the selection page, sorting may be performed based on one or more selection factors of the verification node.

FIG. 6A is shown by using sorting of distances as an example. The user may select to sort exemplary verification nodes based on distances to the scheduling node. As shown in the figure, 4 verification nodes are included, and are respectively 1 Km, 50 Km, 100 Km, and 500 Km away from the scheduling node. Considering that a shorter distance indicates a lowest delay, a recommendation degree of a verification node 1 is the highest, such as a 4-star recommendation degree shown in FIG. 6A, which helps the user select the verification node.

FIG. 6B is shown by using the degree of vacancy as an example. The user may select to sort the exemplary verification nodes based on the degree of vacancy. As shown in the figure, 4 verification nodes are included, and resource utilization rates of the four verification nodes are respectively 20%, 40%, 50%, and 80%. Considering that a higher degree of vacancy indicates higher data processing efficiency, a recommendation degree of the verification node 1 is the highest, such as a 4-star recommendation degree shown in FIG. 6B, which helps the user select the verification node.

Although the above descriptions are respectively shown by using distances or degrees of vacancy as examples, in an actual application process, a comprehensive recommendation degree of each verification node may also be determined based on a combination of a plurality of factors.

Operation 503: The verification node verifies validity of the identity information of the to-be-deployed scheduling node based on information carried in the scheduling node deployment request.

Specifically, when a new scheduling node is added, identity verification needs to be performed on the scheduling node. In one aspect, it is verified whether the identity information of the scheduling node is real, and in another aspect, it is also needed to verify whether the identity information of the scheduling node satisfies a condition for becoming the scheduling node.

As shown in FIG. 5, a process of operation 503 may include the following operations.

Operation 5031: Determine whether correctness verification of public and private keys of the scheduling node deployment request succeeds. This correctness verification is also referred to as a “public-private key correctness verification.”

The correctness verification of public and private keys is generally configured for verifying whether a received message has been tampered with. Therefore, a first operation of receiving the message is performing the correctness verification of public and private keys. When the verification succeeds, the message is not tampered with, and a subsequent process may be continued. If the verification fails, operation 505 is performed, and a result indicating that the verification fails is returned to the deployment device.

Operation 5032: Determine whether the verification of identity information of the scheduling node succeeds if the correctness verification of public and private keys in operation 5031 succeeds.

In a specific application, to improve correctness of the verification of identity information, the verification of identity information may include two parts. One part is an automatic review part. In other words, the identity information may be verified through deployed software. For example, it is verified whether organization information in the identity information actually exists and belongs to an organization that may be added into a scheduling node cluster. The other part may further output a related review page to an administrator for review. For example, the review page may be displayed on a verification node, or the review information may be transmitted to a corresponding administrator. After the administrator completes review, a review result is returned. A manual review may be configured for reviewing identity information that cannot be identified by a computer, or may also perform secondary verification on content reviewed by the computer, to avoid an error in the review by the computer and improve accuracy of verification of identity information.

When the verification succeeds, a subsequent process may be continued. If the verification fails, operation 505 is performed, and a result indicating that the verification fails is returned to the deployment device.

Operation 504: The verification node performs an interface connectivity test on the scheduling node based on the interface information if validity verification of the identity information in operation 503 succeeds.

The interface information is information related to an interface of the foregoing event server. When triggering a related event, the scheduling node needs to transmit the event information to the verification node through the interface. Therefore, it needs to be ensured that a path between the interface and the verification node is already connected, and the verification node needs to perform the interface connectivity test on the interface.

In a possible implementation, the verification node may subscribe to an event of the event server in a subscription manner. When the event server triggers the event, related event information is transmitted to the verification node. The verification node performs a connectivity test, which may be detecting the event server to determine whether the information of the event server can be successfully detected.

In a possible implementation, the verification node may actively obtain the event information from the event server in a polling manner. In other words, the verification node may transmit an information obtaining request to the event server of the scheduling node based on an information obtaining period, to request the event server to transmit updated event information to the verification node. The performing, by the verification node, a connectivity test may be transmitting the information obtaining request to the event server of the scheduling node, and obtaining a result of the interface connectivity test based on whether a response to the information obtaining request is received.

In an actual scenario, the event information may be updated and transmitted in another possible manner, and the verification node may perform the interface connectivity test in a corresponding manner, which is not limited in this embodiment of this application.

Specifically, when the interface connectivity test succeeds, a subsequent process may be continued, namely, operation 506 is performed. Otherwise, if the interface connectivity test fails, operation 505 is performed, and a result indicating that the verification fails is returned to the deployment device.

Operation 505: The verification node returns a result indicating that the verification fails to the deployment device, so that the deployment fails and the process ends.

Operation 506: The verification node adds the scheduling node into the scheduling node cluster, and issue a digital certificate to the scheduling node.

Specifically, issuance of a certificate of the verification node may be specifically implemented through an authentication module included in the verification node. Therefore, the verification node may invoke the authentication module thereof to issue the digital certificate to the scheduling node, which is configured for identity verification of the scheduling node in a subsequent actual process, for example, identity verification during information transmission.

Operation 507: The verification node performs consensus verification on a digital certificate issuance result of the verification node cluster for the scheduling node.

In the embodiments of this application, to improve reliability of storage of the digital certificate of the scheduling node, the digital certificate of the scheduling node may also be stored through a blockchain. A process of issuing the digital certificate to the scheduling node may be performed by the entire verification node cluster. In other words, except the verification node receiving a deployment request, the remaining verification nodes also need to issue the digital certificate to the scheduling node, and each verification node needs to synchronize the digital certificate issued by each verification node to any verification node other than each verification node, so that each verification node performs consensus verification on the digital certificate, and determines that the digital certificate of the consensus is issued to the scheduling node and the digital certificate is uploaded and stored when a consensus is reached.

In a possible implementation, when receiving the scheduling node deployment request, the verification node may synchronize the scheduling node deployment request to another verification node, and the another verification node also performs a related deployment process on the scheduling node deployment request, and issue the digital certificate to the another verification node.

In a possible implementation, when receiving the scheduling node deployment request, the verification node may transmit a digital certificate issuance request to the remaining verification nodes after related verification on the scheduling node deployment request succeeds, to request the another verification node to issue the digital certificate to the scheduling node.

Operation 508: The verification nodes generate a corresponding block and upload the block when consensus verification succeeds, namely, verification nodes corresponding to the blockchain reach a consensus.

Operation 509: The verification node transmits a registration request for the event notification interface to the scheduling node, where the registration request is configured for subscribing to a target type event from the scheduling node.

In a possible implementation, considering that the event server of the scheduling node is exclusively configured to store content related to a system event in the scheduling node, the target type events may include all events of the event server. In other words, the verification node may not select a needed event type, but subscribe to all event updates of the event server by default.

In a possible implementation, the target type event may include event information related to the computing task, for example, related events such as computing task preparation completion, computing node allocation, computing task dispatch, and computing task completion, and certainly, may also include another possible event information, which is not limited in this embodiment of this application.

Operation 510: The verification node starts monitoring the event notification interface. In other words, when the registration succeeds, the scheduling node may consider that work may start to be performed, and the verification node may start to perform detection on the event server of the scheduling node.

Operation 511: The verification node returns deployment success indication information to the scheduling node, where the deployment success indication information carries a digital certificate.

Operation 512: The scheduling node determines whether the result returned by the verification node is correct. If the result is correct, operation 513 is performed, and if the result is incorrect, the process ends.

Specifically, a determining process of the scheduling node may include performing public and private keys verification on the result returned by the verification node, to verify whether the result returned by the verification node has been tampered with, or may include determining a subsequent process based on whether the indication deployment is successful in the result returned by the verification node. For example, if a verification error result returned by the verification node is received, the process ends, and if the deployment success indication information returned by the verification node is received, operation 513 is continued.

Operation 513: The scheduling node obtains the digital certificate issued by the verification node, and stores the certificate in an authentication module of the scheduling node, to formally provide a service to the computing node.

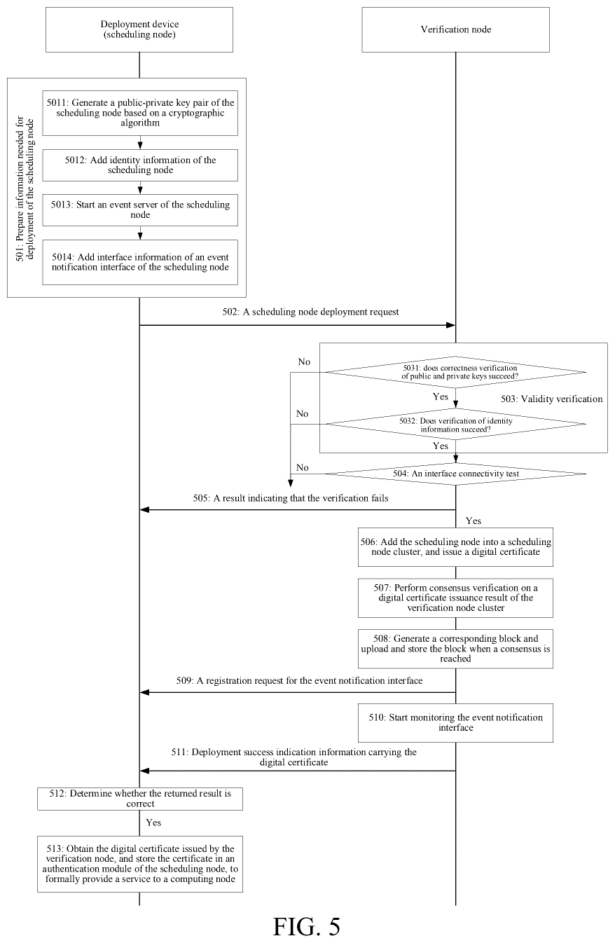

In this embodiment of this application, the computing resources may be extended infinitely. The user may flexibly add a computing device of the user to a computing node cluster as the computing resource of the computing system, and when the computing task needs to be processed, the computing task may be executed based on the computing resources. Therefore, the computing node deployment process is described first herein. The computing node deployment refers to adding a new computing node to the computing node cluster. FIG. 7 is a schematic flowchart of a computing node deployment process according to an embodiment of this application. The process includes the following operations.

Operation 701: A deployment device prepares information needed for deployment of a computing node.

In this embodiment of this application, when a to-be-deployed computing node (also referred to as a “target computing node”) is deployed, necessary information needed for deployment, for example, public and private keys and identity information of the computing node and resource configuration information of the computing node, needs to be provided at a preparation stage. The resource configuration information is configured for representing a computing capability of the computing node, namely, a quantity of computing resources of the computing node, such as a memory size, CPU configuration, and a capability and a quantity of graphics processing units (GPUs).

In a possible implementation, the deployment device may be a terminal device of a user that initiates deployment of a computing node, for example, a personal computer or a tablet computer. The device is configured to initiate a deployment process for a to-be-deployed computing node. The terminal device may present a corresponding deployment page to the user, so that the user may add or generate information related to the to-be-deployed computing node in the deployment page. A quantity of the deployed computing nodes is not limited in this embodiment of this application. One or more computing nodes may be deployed in one deployment process.

In a possible implementation, the deployment device may be the to-be-deployed computing node. In this case, a subsequent deployment process may be initiated through the computing node, which is specifically shown as an example in FIG. 7. For example, related deployment software may be deployed on the computing node. After necessary information (for example, information such as a connected scheduling node) is configured, the deployment software is started to start deployment preparation work.

As shown in FIG. 7, a preparation process may include the following operations.

Operation 7011: Generate a public-private key pair of the computing node based on a cryptographic algorithm, where the private key is configured for encrypting a message when the computing node transmits the message, and the public key is public to another node, and is configured for verifying, when receiving the message transmitted by the computing node, whether the message has been tampered with.

Operation 7012: Add identity information of the computing node, which may mean adding identity information of the computing node in an initiated deployment request, for example, organization information to which the computing node belongs, and is configured for determining an organization from which the computing node comes.

Operation 7013: Add resource configuration information of the computing node, which may mean adding the resource configuration information of the computing node in an initiated deployment request.

Certainly, the preparing node may further include another possible information, which is not limited in this embodiment of this application. In addition, the foregoing operations are not in an actual sequential order, and may be performed simultaneously or in a sequential order during actual application.

Operation 702: The deployment device transmits a computing node deployment request to a scheduling node, and the scheduling node receives the computing node deployment request.

The computing node deployment request may carry identity information of the to-be-deployed computing node and the resource configuration information.

In a possible implementation, the event server is used as a notification manner provided by the scheduling node externally, or may be used as a notification manner for interaction between the outside and the scheduling node. In this case, the deployment device may transmit the computing node deployment request to the event server of the scheduling node.

In a possible implementation, the deployment device may alternatively transmit the computing node deployment request to the scheduling node in a manner of directly transmitting the message.

In this embodiment of this application, each computing node is connected to one scheduling node, so that the user may select the scheduling node corresponding to a to-be-deployed computing node. Similar to the foregoing selection of the verification node, the user may select a scheduling node based on distances, or may select the scheduling node based on a degree of load resource vacancy of the scheduling node. Alternatively, when the user does not perform selection, the system may allocate the scheduling node for the user.

Operation 703: The scheduling node verifies validity of the identity information of the to-be-deployed computing node based on information carried in the computing node deployment request.

Specifically, when a new computing node is added, identity verification needs to be performed on the computing node. In one aspect, it is verified whether the computing node deployment request has been tampered with, and in another aspect, it is also needed to verify whether the identity information of the computing node is real.

As shown in FIG. 7, a process of operation 703 may include the following operations.

Operation 7031: Determine whether correctness verification of public and private keys of the computing node deployment request succeeds.

The correctness verification of public and private keys is generally configured for verifying whether a received message has been tampered with. Therefore, a first operation of receiving the message is performing the correctness verification of public and private keys, namely, an operation of signature verification. When the verification succeeds, the message is not tampered with, and a subsequent process may be continued. If the verification fails, operation 705 is performed, and a result indicating that the verification fails is returned to the deployment device.

Operation 7032: Determine whether verification of identity information of the computing node succeeds if the correctness verification of public and private keys in operation 7031 succeeds.

In a specific application, to improve correctness of the verification of identity information, the verification of identity information may include two parts. One part is an automatic review part. In other words, the identity information may be verified through deployed software. For example, it is verified whether organization information in the identity information actually exists and belongs to an organization that may be added into a computing node cluster. The other part may further output a related review page to an administrator for review. For example, the review page may be displayed on a scheduling node, or the review information may be transmitted to a corresponding administrator. After the administrator completes review, a review result is returned. A manual review may be configured for reviewing identity information that cannot be identified by a computer, or may also perform secondary verification on content reviewed by the computer, to avoid an error in the review by the computer and improve accuracy of verification of identity information.

When the verification succeeds, a subsequent process may be continued. If the verification fails, operation 705 is performed, and a result indicating that the verification fails is returned to the deployment device.

Operation 704: The scheduling node determines whether the computing device satisfies a minimum configuration need of the computing node based on the resource configuration information if validity verification of the identity information in operation 703 succeeds.

Generally, the computing node needs to be configured to execute the computing task. Therefore, a need on hardware configuration thereof exists. If the hardware configuration cannot satisfy the need, it may be difficult for the computing node to execute the computing task, and the computing node is unsuitable as the computing node. The configuration need may be preset, namely, added as a minimum computing resource need of the computing node, so that it is needed to determine whether the minimum computing resource need is satisfied for the computing device one by one, for example, whether memory is sufficient, or whether CPU configuration satisfies a predetermined configuration need.

Specifically, when the computing device satisfies the configuration need of the computing node, a subsequent process may be continued, namely, operation 706 is performed. Otherwise, if the computing device does not satisfy the configuration need of the computing node, operation 705 is performed, and a result indicating that the verification fails is returned to the deployment device.

Operation 705: The scheduling node returns a result indicating that the verification fails to the deployment device, so that the deployment fails and the process ends.

Operation 706: The scheduling node adds the computing node to the computing node cluster, and issues a digital certificate to the computing node.

Issuance of a certificate of the scheduling node may be specifically implemented through an authentication module included in the verification node. Therefore, the scheduling node may invoke the authentication module thereof to issue the digital certificate to the computing node, which is configured for identity verification of the computing node in a subsequent actual process, for example, identity verification during information transmission with another node.

Similar to deployment of the scheduling node, to improve reliability of storage of the digital certificate of the computing node, the digital certificate of the computing node may also be stored through a blockchain. A process of issuing the digital certificate to the computing node may be performed by the entire scheduling node cluster. In other words, except the scheduling node receiving a deployment request, the remaining scheduling nodes also need to issue the digital certificate to the computing node, and each scheduling node needs to synchronize the digital certificate issued by each scheduling node to any scheduling node other than each scheduling node, so that each scheduling node performs consensus verification on the digital certificate, and determines that the digital certificate of the consensus is issued to the computing node and the digital certificate is uploaded and stored when a consensus is reached.

In a possible implementation, when receiving the computing node deployment request, the scheduling node may synchronize the computing node deployment request to another scheduling node, and the another scheduling node also performs a related deployment process on the computing node deployment request, and issue the digital certificate to the another scheduling node.

In a possible implementation, when receiving a computing node deployment request, the scheduling node may transmit a digital certificate issuance request to the remaining scheduling nodes after related verification on the computing node deployment request succeeds, to request other scheduling nodes to issue a digital certificate to the computing node.

Operation 707: Update a node state table through the computing device.

Specifically, the node state table is configured for storing a node state of each computing node connected to the node state table. The node state may indicate whether a corresponding computing node is available, or indicate a state of a computing resource of the computing node, such as memory occupation or CPU occupation.

Operation 708: The scheduling node returns deployment success indication information to the computing node, the deployment success indication information carrying a digital certificate.

Operation 709: The computing node determines whether the result returned by the scheduling node is correct. If the result is correct, operation 710 is performed, and if the result is incorrect, the process ends.

Specifically, a determining process of the computing node may include performing public and private keys verification on the result returned by the scheduling node, to verify whether the result returned by the verification node has been tampered with, or may include determining a subsequent process based on whether the indication deployment is successful in the result returned by the scheduling node. For example, if a verification error result returned by the scheduling node is received, the process ends, and if the deployment success indication information returned by the scheduling node is received, operation 710 is continued.

Operation 710: The computing node obtains the digital certificate issued by the scheduling node, and stores the certificate in an authentication module of the computing node, to formally provide a service to the scheduling node.

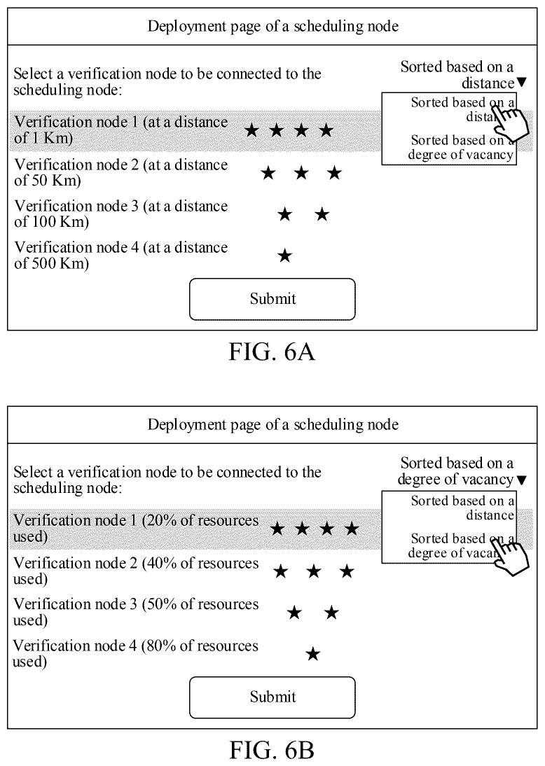

In this embodiment of this application, the computing task scheduling and allocation process is a process of performing random allocation and scheduling on a computing task. In other words, the user needing performing computation may transmit the computing task to a designated scheduling node, and randomly selects the computing node based on a random seed transmitted by the user, thereby ensuring fairness and security of the computing task. A computing result event subscription and verification process is a process in which a verification node performs event subscription to a computing result and verifies event validity. The two processes are related in execution. Therefore, the processes are described below with reference to each other. FIG. 8 is a schematic flowchart of a data processing method according to an embodiment of this application. The process includes the foregoing computing task scheduling and allocation process and the computing result event subscription and verification process. A specific implementation process of the method is as follows.

Operation 801: A task submission end submits a computing request, and a scheduling node receives the computing request transmitted by the task submission end.

In this embodiment of this application, after preparing code and data needed for a computing task, a user needing performing computation may perform a task computing operation after completing configuration in a computing task submission page provided by the task submission end, and trigger the task submission end to transmit a computing request to the scheduling node.

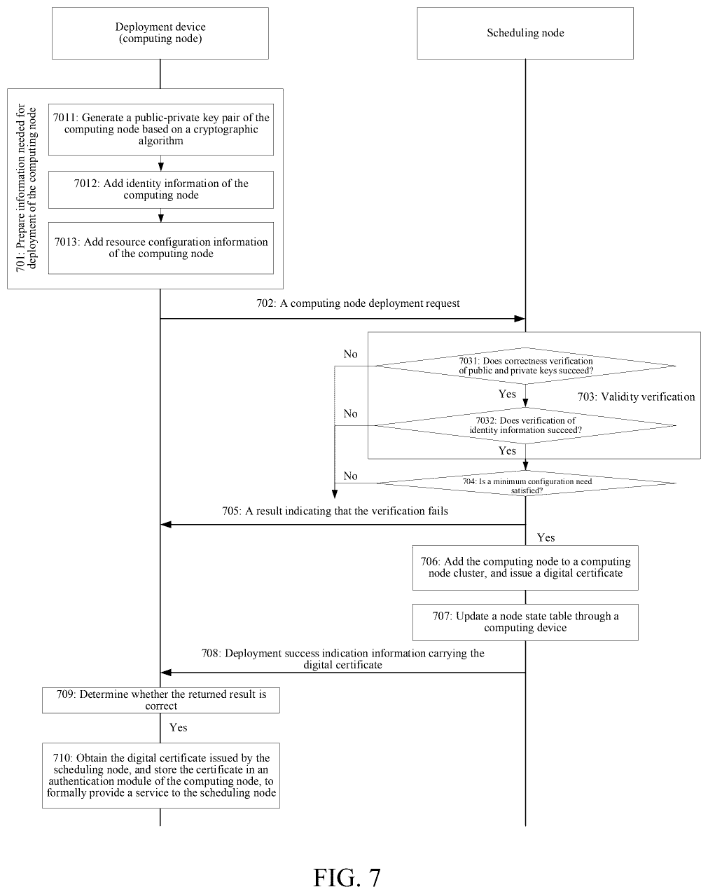

FIG. 9A is a schematic diagram showing a computing task submission page according to an embodiment of this application. When a computing task is submitted, code and data needed for the computing task and a computing node configuration need expected by a user for the computing task need to be provided are showed, for example, a quantity (a redundant number) k of needed computing nodes.

To ensure fairness of task allocation, the user further needs to set a random seed corresponding to a current computing task, which is to be used by the scheduling node as a basis when the scheduling node dispatches a computing node for the computing task. The computing request may include a random seed provided by the task submission end for a corresponding computing task. For example, the user may select a random number r from [0, max) (max is a large number).

Although random number-based selection is involved herein, a selection process also has a specific law. Therefore, when the user gives a random number, a computing node that needs to be selected for the random number is determined. Therefore, essentially, when the user provides a random number, a computing node that may be finally allocated may further be presented for the random number, so as to assist the user in making a selection. FIG. 9B is a schematic diagram showing a computing node selection interface according to an embodiment of this application. The interface includes an input window of a random seed. After a user inputs the random seed in the window again, a system may determine, based on a current system state, a computing node list corresponding to the random seed, and present the list to the user. The user may determine whether the user needs these computing nodes to execute a computing task of the user. If yes, the user determines the list. If no, the user may change a computing node by modifying a random number.

Alternatively, a button for generating the random number may be provided, for example, a dice button shown in FIG. 9B. The user clicks the button, the random number may be randomly generated as the random seed for the user. In addition, if the user wishes to specify the computing node, the user may also directly select a corresponding computing node to execute the computing task, or input information of the computing node and then infer an anti-inference random seed for the computing node.

After the related configuration is completed, the user may sign the code, the data, and the random number, and transmit the code, the data, and the random number to a corresponding scheduling node, so that a network module of the scheduling node receives the foregoing computing request. The scheduling node may be selected by the user, for example, selected based on distances or degrees of vacancy. Alternatively, a system may recommend a scheduling node to the user. Alternatively, when the user does not select the scheduling node, the system may also allocate the scheduling node to the user, for example, allocate the computing task to a corresponding scheduling node based on a load balancing algorithm.

Operation 802: The scheduling node obtains a candidate computing node set for the computing task, and determine, from the candidate computing node set, a first computing node set configured for executing the computing task based on a second random number set derived by the random seed.

In this embodiment of this application, in the manner of deriving a random number by the random seed, a second random number of a quantity of needed computing nodes is derived, and each second random number corresponds to one computing node, so that a corresponding quantity of computing nodes may be obtained.

During an actual application, each scheduling node generally can schedule only computing nodes connected to the scheduling node. Therefore, all or some computing nodes need to be selected from computing nodes (namely, computing nodes connected to the scheduling node) in the computing node cluster that can be scheduled by the scheduling node, to form the candidate computing node set. Certainly, when some computing nodes are selected to form the candidate computing node set, selection may be performed based on node states of the computing nodes. For example, relatively idle computing nodes or computing nodes satisfying a hardware condition are selected to form the candidate computing node set, and the load balancing module may obtain all active computing nodes in the node state table to form the candidate computing node set.

In a possible implementation, to ensure security of the computing request and avoid a waste of computing resources, the received computing request needs to be authenticated (for example, whether a task submission end transmitting the computing request has a task execution right), and after the authentication succeeds, the first computing node set for executing the computing task is determined from the candidate computing node set by using the second random number set derived based on the random seed. The process may be specifically implemented through an authentication module of the scheduling node.

In an embodiment, when receiving the computing request, the scheduling node may determine, by using an authentication algorithm such as a public/private key authentication algorithm, whether authentication of the computing request succeeds. In other words, the computing request is decrypted through the public key of the task submission end to obtain first digest information carried in the computing request. Moreover, digest extraction is performed on the carried information to obtain second digest information, and whether authentication succeeds is determined based on the first digest information and the second digest information Such authentication is mainly to avoid a computing task from being tampered with during a transmission process. In addition, whether the task submission end has permission to submit a computing task may also be verified.

In a possible implementation, the computing task further needs to be verified. In one aspect, validity of the computing task needs to be verified. For example, timeliness of the task and whether parameters of the computing task are valid are verified based on a timestamp. Only when the task is valid, a subsequent process is continued to perform computing. In another aspect, whether a computing result cache already exists for the computing task further needs to be verified. In other words, computation has been historically performed for the computing task. If yes, a historical computing result may be directly reused, to avoid a waste of computing resources by repeated calculation. If no, a subsequent process is continued to perform computation.

In an actual application, a plurality of computing tasks that need to be scheduled in the scheduling node may exist. A plurality of task queues are cached in a task queue of the scheduling node to be executed. The scheduling node needs to sort the computing tasks in the queue, so that the computing tasks are successively scheduled and executed based on priorities.

In a possible implementation, the priority of each computing task may be considered from a plurality of aspects. One aspect is a conflict between computing tasks. Some computing tasks are in conflict and cannot be executed in parallel. In other words, a subsequent computing task can be continued until execution of a previous computing task is completed. These computing tasks need to be executed in sequence based on a conflict sequence, for example, same transactions of the same account or associated transactions. In another aspect, sorting may be performed based on time consumptions of computing tasks. When one computing task extremely takes time, execution of a plurality of computing tasks may be blocked. Therefore, a time consumption problem needs to be considered during scheduling. In still another aspect, the sorting may be performed based on a pre-configured priority. For example, a priority of a computing task of a certain type is configured to be higher than that of a computing task of another type.

In this embodiment of this application, a random selection algorithm is initialized through a random seed to obtain a corresponding second random number set as a basis for selecting a computing node. A specific process of the random selection algorithm is described in detail subsequently. Therefore, details are not repeated herein again.

Operation 803: The scheduling node dispatches the computing task to each computing node in the first computing node set, the computing node receiving the computing task.

Specifically, the scheduling node encapsulates a message transmitted by the user, signs the message, and respectively transmits a computing request obtained through encapsulation to each computing node in the first computing node set. Alternatively, the scheduling node may transmit the computing task to each computing node through an event server. In other words, after encapsulating and signing the message transmitted by the user, the scheduling node starts a subscription port, and instructs each computing node to obtain and execute the computing task.

In a possible implementation, after receiving a computing request, the computing node may sign a computed task identity (ID), and return the signature to the scheduling node, so that the scheduling node collects event task information of the computing task and stores the event task information into the event server. Therefore, all nodes subscribing to the event server can sense the event task information. The event task information includes, for example, information such as a task ID, a signature of the task ID, a user request, and a signature of the user request.

Operation 804: The computing node executes the computing task to obtain a corresponding computing result, and signs the computing result based on a digital certificate of the computing task, to obtain a corresponding signature.

When a plurality of computing nodes exist in the first computing node set, the scheduling node divides the computing task into a plurality of sub-tasks that are respectively allocated to different computing nodes.

Operation 805: The computing node returns a computing result obtained by executing the computing task and a signature of the computing result to the scheduling node.

The computing node transmits the signature of the computing result to a scheduling node connected to the computing node, so that the scheduling node generates task event information and a signature for the task event information, and transmits the task event information and the signature for the task event information to a verification node connected to the scheduling node. Therefore, the verification node verifies validity of the first computing node set. The task event information includes the first computing node set participating in execution of the computing task and a random seed provided by the task submission end of the computing task.

Operation 806: The scheduling node updates the computing task to a completed state when the computing results of all first computing nodes in the first computing node set are received.

Operation 807: The verification node determined that the computing task is in the completed state.

In a possible implementation, the scheduling node may transmit a notification message that the task is completed to the verification node, so that the verification node can learn that the computing task is in the completed state.

In a possible implementation, the event server of the scheduling node is an external message notification mechanism. The verification node subscribes to the event server. Therefore, when the scheduling node may update a task state of the computing task in the event server to the completed state, the event server may transmit the notification message to the verification node, and the verification node may correspondingly learn that the state of the computing task is updated to the completed state.

Operation 808: The verification node obtains the task event information of the computing task and the signature for the task event information.

The verification node may request the task event information and the signature for the task event information from the scheduling node, or may obtain the task event information and the signature for the task event information through the event server of the scheduling node. The task event information may include the first computing node set participating in execution of the computing task and a random seed provided by the task submission end of the computing task.

Operation 809: Verify the signature for the task event information. Whether the task event information from the scheduling node has been tampered with may be determined by verifying the signature for the task event information. For example, in this embodiment of this application, the signature may be decrypted through the public key of the scheduling node, to obtain the first digest information of the task event information generated by the scheduling node. Digest extraction is performed on the task event information to obtain second digest information, and whether the verification of the signature succeeds is determined based on the first digest information and the second digest information.

Operation 810: Derive the first random number set based on the random seed when verification of the signature for the task event information succeeds. A derivation manner is the same as the foregoing manner of generating the second random number set herein. If the second random number set received by the verification node has not been tampered with, the second random number set needs to be consistent with the first random number set.

Operation 811: Select, for the computing task, a second computing node set associated with the first random number set from the computing node cluster. In an embodiment, the second computing node set may be determined in the following manners in this embodiment of this application:
selecting a candidate computing node set from the computing node cluster; for example, selecting the candidate computing node set from a plurality of computing nodes in the computing node cluster that are connected to the scheduling nodes;
respectively determining, for each candidate computing node in the candidate computing node set, a random number range corresponding to each candidate computing node based on an evaluation value of each candidate computing node representing an availability degree of a computing resource, the random number ranges corresponding to the candidate computing nodes not overlapping; and
performing the following operation based on each first random number in the first random number set: adding, for each first random number, a candidate computing node corresponding to a random number range in which the first random number is located to the second computing node set.

Operation 812: Verify validity of the first computing node set by using the second computing node set, to obtain a corresponding verification result.

Operation 813: Add a block including the verification result to a blockchain of the verification node cluster.

In some embodiments of this application, consensus on a computing result in a conventional blockchain-based cluster system is discarded, and verification on a random event (for example, generating a first random number set) is converted to ensure credibility of nodes in the system. Specifically, verification is performed on a random allocation process of computing nodes of the scheduling node, to verify validity of the first computing node set allocated by the scheduling node.

Therefore, the verification node may allocate the computing node again based on the same random allocation method, to verify whether the first computing node set allocated by the scheduling node is valid.

Similarly, when receiving the task event information transmitted by the scheduling node connected to the verification node, the verification node may obtain the signature of the scheduling node for the task event information, and decrypt the signature information through the public key (for example, which may be obtained through the certificate carried in the signature of the scheduling node) of the scheduling node to obtain the first digest information of the task event information generated by the scheduling node. In addition, digest extraction is performed on the task event information, to obtain the second digest information, and whether verification on the signature succeeds is determined based on the first digest information and the second digest information. Only when verification of the signature succeeds, the second computing node set executing the computing task is determined by using the first random number set derived based on the random seed. Otherwise, when verification fails, the task event information may be tampered with, and the second computing node set needs to be discarded.

To verify validity of the first computing node set, the verification node compares the first computing node set with the second computing node set, to obtain a verification result identifying whether the first computing node set is consistent with the second computing node set.

The first computing node set is selected by the corresponding scheduling node from the candidate computing node set by using the second random number set derived based on the random seed.

In an embodiment, when the verification result indicates that the second computing node set is consistent with the first computing node set, the validity verification of the first computing node set allocated by the scheduling node succeeds. Otherwise, when the second computing node set is inconsistent with the first computing node set, the validity verification of the first computing node set allocated by the scheduling node fails.

In this embodiment of this application, a block producing process (namely, a block is added into a blockchain) of the verification node may be divided based on time or a quantity of verification events. Using the quantity of verification events as an example, when a quantity of completed computing tasks reaches a threshold needed for block producing, a new block is created, a scheduling and allocation result of each computing task in the block is verified, and after all validity verification results reach a consensus between verification nodes, the block is uploaded and stored (namely, the block is added into the blockchain).

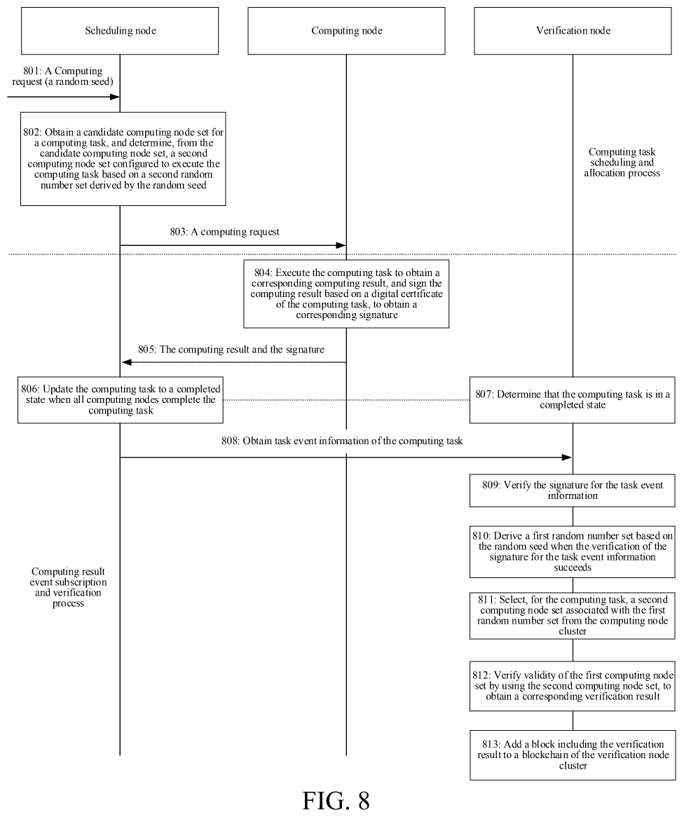

In this embodiment of this application, the foregoing processes in which the verification node and the scheduling node derive the random number set based on the random seed to select the computing node are the same. Therefore, the processes are uniformly described below. FIG. 10 is a schematic flowchart of a random selection process according to an embodiment of this application. In the following process, a random seed is represented as r, and a quantity of computing nodes that need to be selected is k.

Operation 1001: Respectively determine, for each candidate computing node in a candidate computing node set, a random number range corresponding to each candidate computing node based on an evaluation value representing an availability degree of a computing resource.

The evaluation value of each computing node representing the availability degree of the computing resource is configured for dividing the computing nodes, so as to position the computing node in a unique random number range. In other words, the random number ranges corresponding to all candidate computing nodes do not overlap with each other. The evaluation value representing the availability degree of the computing resource is an evaluation value of a combination of one or more resource attributes of the computing node. The resource attributes include, for example, a memory occupation rate, a CPU occupation rate, or another computing resource attribute. Therefore, the evaluation value representing the availability degree of the computing resource is a score of one or more resource attributes of the node. For example, the score may be a node resource score, and can be configured for representing a resource availability degree of the computing node.

In a possible implementation, each candidate computing node may be divided into a plurality of random number ranges through an accumulated value of evaluation values, so as to subsequently use, based on a random number range in which each derived random number (namely, the first random number set or the second random number set above) falls, a candidate computing node corresponding to the random number range as a to-be-allocated computing node (namely, the first computing node set or the second computing node set above).

Exemplarily, a node resource score is used as an example herein. Referring to the following Table 1, for a node 1, a node resource score (namely, an evaluation value) thereof is 90, and a corresponding random number range thereof is in a range of 0 to 89. A node resource score of a node 2 is 80, and an accumulated value of the two nodes is 170. Therefore, a random number range corresponding to the node 2 is in a range of 90 to 169. A node resource score of a node 3 is 85, and an accumulated value is 255. Therefore, a random number range corresponding to the node 3 is in a range of 170 to 254. The rest may be deduced by analogy when a quantity of nodes increases.

TABLE 1

| Computing node ID | Node resource score | Random number range |
|---|---|---|
| 1 | 90 | 0-89 |
| 2 | 80 | 90-169 |
| 3 | 85 | 170-254 |

Operation 1002: Initialize a random number selection factor by using the random seed, namely, use the random seed as an initial value of the random number selection factor, for example, set a random number selection factor as p=r, and set a number of a currently selected node as x=1.

In this embodiment of this application, a process of deriving a random number is an iterative process. If a quantity of computing nodes needed for a computing task is K, K computing nodes need to be obtained, so that an iterative selection process needs to be performed for K times. Each selection process is similar. Therefore, a description is provided by mainly using one selection process as an example subsequently. Each selection process includes the following operations.

Operation 1003: Determine whether a value of a quantity x of rounds is greater than K, and end the process if x is greater than K, or perform operation 1004 if not.

Operation 1004: Obtain a random number corresponding to a current round based on an evaluation value sum of the candidate computing node set and a random number selection factor p used in the current round.

Specifically, a remainder of the evaluation value sum relative to the random number selection factor used in the current round may be obtained by using the evaluation value sum as a divisor and the random number selection factor used in the current round as a dividend, and the remainder is determined as the random number corresponding to the current round. In other words, the random number corresponding to the current round is p/N, and N is an evaluation value sum.

Operation 1005: Select a computing node corresponding to the current round from the candidate computing node set based on a random number range in which the random number is located.

Exemplarily, if a remainder of the current round is 70, a random number range in which the remainder is located is in a range of 0 to 89, namely, corresponding to the foregoing node 1. Therefore, the node 1 is the computing node corresponding to the current round.

Operation 1006: Update the random number selection factor used in the current round, to obtain a random number selection factor to be used in a next round.

Specifically, the random number selection factor may be updated by selecting an update factor that is public and transparent and whose value is as large as possible. For example, an example in which a block hash value of a certain height in the blockchain is used as the update factor may be used. In an actual application, another value such as the height of the block may alternatively be selected as the update factor, which is not limited in this embodiment of this application.

Using an example in which a block hash value of a certain height in the blockchain is used as an update factor, hash value mapping processing may be performed on a (c−z)^{th} block in the blockchain, to obtain a corresponding hash value. Next, the random number selection factor used in the current round is updated based on the hashed value, to obtain a random number selection factor to be used in a next round, c being a serial number of a latest block in the blockchain, and x being a quantity of rounds of the iterative selection process.

In a possible implementation, updating the random number selection factor used in the current round may be represented as:

p=p*hash(c−x).

Operation 1007: Increase a quantity of iteration rounds by one, i.e., x=x+1, and continue to perform operation 1003.

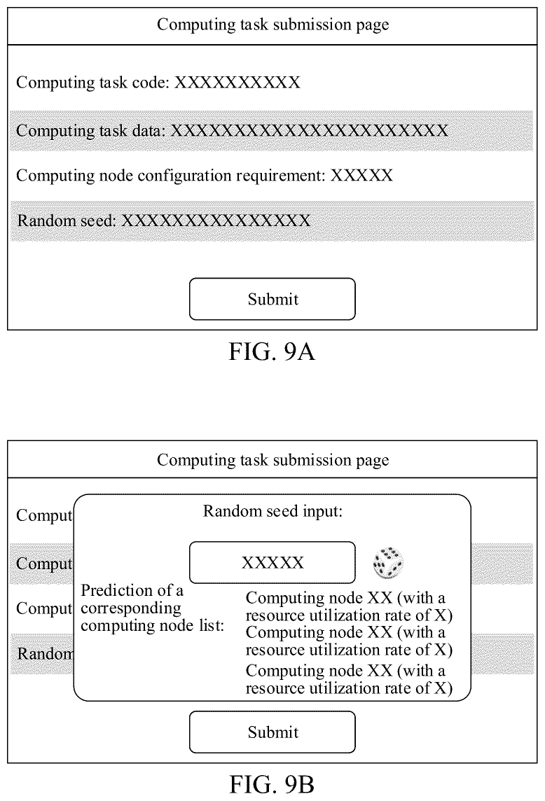

The computing task scheduling and allocation process is described below through a specific example. FIG. 11 is a schematic flowchart of a computing task scheduling and allocation process according to an embodiment of this application.

Operation 1101: A task submission end prepares code and data needed for a task.

Operation 1102: The task submission end selects a random seed r and a quantity k of needed computing nodes.

Operation 1103: The task submission end signs and transmits the code, the data, and the random seed to a selected scheduling node.

Operation 1104: A network module of a scheduling node receives the foregoing computing request.

Operation 1105: An authentication module of the scheduling node authenticates the scheduling node, and determines whether the authentication succeeds, namely, whether the computing request has been tampered with needs to be verified based on the signature of the computing request, and whether the certificate is authentic is verified. If so, operation 1106 is performed, and if not, operation 1109 is performed.

Operation 1106: The scheduling node determines whether task verification succeeds, for example, whether a timestamp expires, or whether a parameter is invalid. If yes, operation 1107 is performed, and if no, operation 1109 is performed.

Operation 1107: The scheduling node determines whether a computing result cache exists in the computing task. If yes, operation 1108 is performed, and if no, operation 1109 is performed.

If the same computing task has the same code number and the same data number, the code number and the data number may be compared to determine whether the code number and the data number are the same. The code number and the data number may be, for example, digest values obtained by performing hash calculation on the code and the data.

Operation 1108: The scheduling node returns the cached computing result, and the process on the scheduling node side ends.

Operation 1109: Return a result indicating that the verification fails, and end a process on a scheduling node side.

Operation 1110: The scheduling node places the computing task into a task queue for execution.

Operation 1111: The scheduling node performs sorting on the task queue based on a priority.

Operation 1112: A load balancing module of the scheduling node obtains all active nodes in the node state table as candidate computing nodes, and performs statistics collection on a node resource score of each candidate computing node and a total score N.

Operation 1113: The load balancing module of the scheduling node prepares for task dispatching to the nodes for execution, for example, packages task data.

Operation 1114: The load balancing module of the scheduling node performs an initialization operation of computing node selection. In other words, k nodes in the candidate computing nodes execute a task. If the current node is represented as x, x is initialized to 1, and a selection factor p is initialized to r.

Operation 1115: The scheduling node determines whether K computing nodes are selected, namely, determines whether x>k is satisfied. If yes, operation 1119 is performed, and if no, operation 1116 is performed.

Operation 1116: A computing node selected by the scheduling node for an x^{th} node is a computing node corresponding to p/N. In other words, the range of 1 to N may be divided into a plurality of random number range intervals by various computing nodes, and a computing node ID is obtained based on the intervals.

Operation 1117: The scheduling node updates the random number selection factor, namely, p=p*hash(c−x), hash( ) representing a block hash value of a certain height, c being a latest block in the blockchain.

Operation 1118: Increase a quantity of rounds of iterations of the scheduling node by one, i.e., x=x+1, and perform operation 1115.

Operation 1119: The scheduling node completes selection for all computing nodes.

Operation 1120: The scheduling node encapsulates and signs a computing request message transmitted by the user.

Operation 1121: The scheduling node starts a subscription port and instructs the selected computing node to obtain and execute the task.

Operation 1122: All computing nodes sign the computing task ID.

Operation 1123: The scheduling node collects and stores signatures for the computing task ID, the task ID, the user request, and a signature for the user request into an event server.

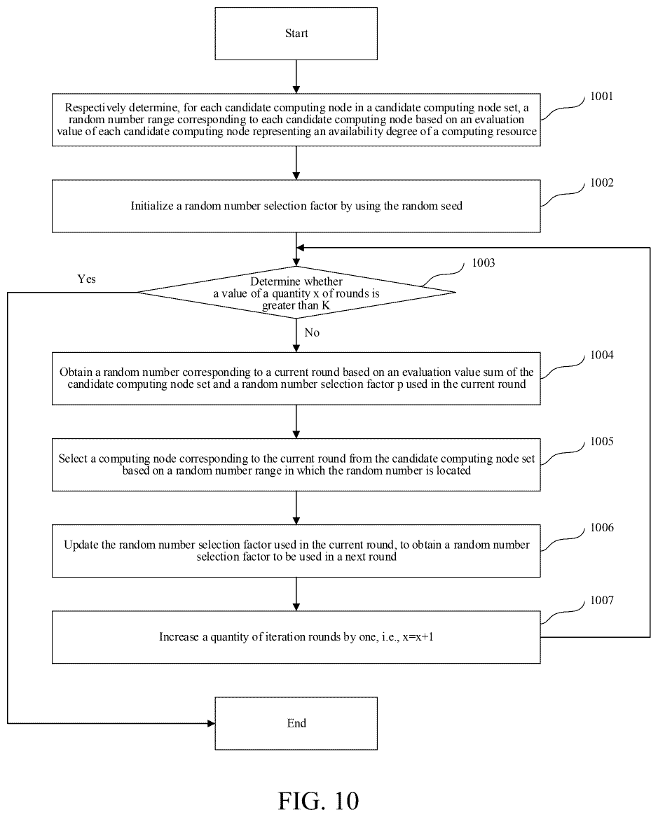

A process in which the verification node performs event subscription to a computing result and verifies event validity is described below by using a specific example. FIG. 12 is a schematic flowchart of a computing task scheduling and allocation process according to an embodiment of this application.

Operation 1201: A network module of a computing node subscribes to a to-be-executed computing task.

Operation 1202: The network module of the computing node receives a computing task dispatched by a scheduling node when the computing node is selected as a task execution node.

Operation 1203: An authentication module of the computing node authenticates the computing node and determines whether the authentication succeeds. In other words, whether a computing request has been tampered with needs to be verified based on a signature provided by the scheduling node for the computing request, whether authentication based on a certificate succeeds, and the like. If yes, operation 1205 is performed, and if no, operation 1204 is performed.

Operation 1204: The computing node returns a result indicating that the verification fails, and the process ends.

Operation 1205: The computing node places the computing task into a task queue based on an order of priorities.

Operation 1206: A task execution module of the computing node schedules the computing task, and immediately executes the computing task if a resource exists; otherwise, waits to execute the computing task.

Operation 1207: A process or a protocol in the task execution module of the computing node starts to execute the task.

Operation 1208: The computing node returns a task execution result to the scheduling node, the task execution result including a computing result and signature information for the computing result.

Operation 1209: The scheduling node determines whether the task executed by all the computing nodes is completely executed. If yes, operation 1210 is performed, and if no, operation 1202 is performed.

Operation 1210: The scheduling node stores execution code and the result into an execution code and data storage of a storage module.

Operation 1211: The scheduling node updates an execution state of the computing task in an event server to a completed state.

Operation 1212: An event detection module of the verification node detects a new event of the event server of the scheduling node, namely, the execution state of the foregoing computing task is the completed state.

Operation 1213: The verification node receives the related information transmitted by the scheduling node, and verifies whether the signature succeeds. If yes, operation 1215 is performed, and if no, operation 1214 is performed.

Operation 1214: The verification node discards a computing result, and the process ends.

Operation 1215: The verification node places the computing task into a random number verification task scheduler.

Operation 1216: The scheduler completes scheduling, and places the computing task into a random number verification task dispatcher.

Operation 1217: The dispatcher dispatches a random number verification task of the computing task to a specific executor, and a random number verification task executor executes the verification task.

Operation 1218: A random number verification result processor processes a result of the random number verification.

Operation 1219: Determine whether the verification result is correct. If yes, operation 1221 is performed, and if no, operation 1220 is performed.

Operation 1220: Store a result indicating that the verification fails in a verification result storage, namely, upload and store the verification result, and end the process.

Operation 1221: Store a result indicating that the verification succeeds in a verification result storage, namely, upload and store the verification result, and end the process.

Based on the above, the embodiments of this application provide a multi-party computation solution based on a plurality of architecture blockchains. The solution can ensure infinite scalability of multi-party computation. Each user may access a computer thereof to a nearest scheduling node, and provide a specific computing power as the computing node. A user needing computation may transmit a computing task to a designated scheduling node, and randomly select a computing node based on a random seed transmitted by the user, thereby ensuring fairness and security of the computing task. Finally, identities of all nodes can be ensured to be trustworthy through a plurality of certificate authority mechanisms.

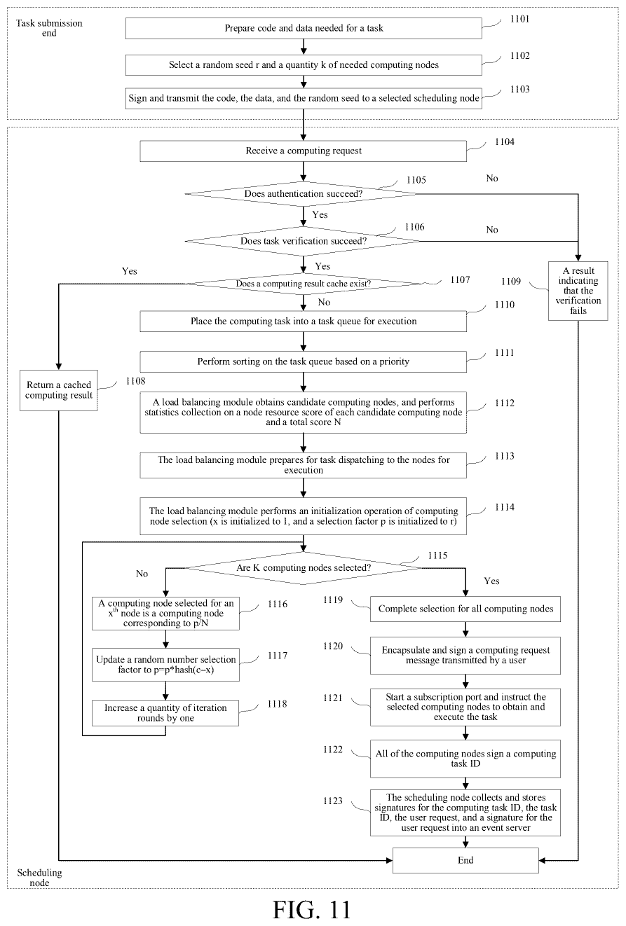

As shown in FIG. 13, based on the same inventive concept, an embodiment of this application further provides a data processing apparatus 130, which is applied to any verification node in a verification node cluster included in a computing system, and the computing system further includes a scheduling node cluster and a computing node cluster. The apparatus includes:
an event subscription unit 1301, configured to obtain task event information and a signature for the task event information from a scheduling node in the scheduling node cluster, the task event information including a first computing node set participating in execution of a computing task and a random seed provided by a task submission end of the computing task; and
a node selection unit 1302, configured to: verify the signature; derive a first random number set based on the random seed when the verification of the signature succeeds; and select, for the computing task, a second computing node set associated with the first random number set from the computing node cluster;
a comparison unit 1303, configured to verify validity of the first computing node set by using the second computing node set, to obtain a corresponding verification result; and
a creation unit 1304, configured to add a block including the verification result to a blockchain of the verification node cluster.

In a possible implementation,
each verification node in the verification node cluster is connected to at least one scheduling node in the scheduling node cluster, each scheduling node being uniquely connected to a verification node;
each scheduling node in the scheduling node cluster is connected to at least one computing node in the computing node cluster, each computing node being uniquely connected to a scheduling node; or
the scheduling node cluster includes a plurality of scheduling node sub-clusters, each scheduling node sub-cluster including N levels of scheduling nodes, N being a positive integer greater than 1, a first level of scheduling node of the N levels of scheduling nodes being connected to a next level of scheduling node, a last level of scheduling node being connected to at least one computing node and being connected to a previous level of scheduling node, and an i^{th} level of scheduling node being connected to an (i−1)^{th} level of scheduling node and an (i+1)^{th} level of scheduling node, i being a positive integer greater than 1 and less than N.

In a possible implementation, the node selection unit 1302 is specifically configured to:
select a candidate computing node set from the computing node cluster;
respectively determine, for each candidate computing node in the candidate computing node set, a random number range corresponding to each candidate computing node based on an evaluation value of each candidate computing node representing an availability degree of a computing resource, the random number ranges corresponding to the candidate computing nodes not overlapping; and
perform the following operation based on each first random number in the first random number set:
adding, for each first random number, a candidate computing node corresponding to a random number range in which the first random number is located to the second computing node set.

In a possible implementation, the node selection unit 1302 is specifically configured to:
perform K rounds of iterative selection processes by using the random seed as an initial value of a random number selection factor, to obtain the first random number set, K being a quantity of computing nodes needed for the computing task, and each round of selection process including the following operations:
obtaining a random number corresponding to a current round based on an evaluation value sum of the candidate computing node set and a random number selection factor used in the current round; and
updating the random number selection factor used in the current round, to obtain a random number selection factor to be used in a next round.

In a possible implementation, the node selection unit 1302 is specifically configured to:
obtain a remainder of the evaluation value sum relative to the random number selection factor used in the current round by using the evaluation value sum as a divisor and the random number selection factor used in the current round as a dividend; and
determine the remainder as the random number corresponding to the current round.

In a possible implementation, the node selection unit 1302 is specifically configured to:
perform hash value mapping on a (c-x)^{th} block in the blockchain, to obtain a corresponding hash value, c being a serial number of a latest block in the blockchain, and x being a quantity of rounds of the iterative selection process; and
update the random number selection factor used in the current round based on the hash value, to obtain the random number selection factor to be used in the next round.

In a possible implementation, the apparatus further includes an authentication unit 1305, which is configured to:
decrypt the signature through a public key of the scheduling node, to obtain first digest information of the task event information generated by the scheduling node; and
perform digest extraction on the task event information to obtain second digest information, and determine whether the verification of the signature succeeds based on the first digest information and the second digest information.

The node selection unit 1302 is specifically configured to determine, when verification of the signature information succeeds from the candidate computing node set, a second computing node set executing the computing task based on a first random number set derived by the random seed.

In a possible implementation, the apparatus further includes a node deployment unit 1306, which is configured to:
receive a scheduling node deployment request, the scheduling node deployment request carrying identity information of a to-be-deployed scheduling node and interface information of an event notification interface;
perform an interface connectivity test on the scheduling node based on the interface information if validity verification of the identity information succeeds;
add the scheduling node to the scheduling node cluster and issue a digital certificate to the scheduling node if the interface connectivity test succeeds;
transmit a registration request for the event notification interface to the scheduling node when consensus verification performed by the verification node cluster on a digital certificate issuance result of the scheduling node succeeds, the registration request being configured for subscribing to a target type event from the scheduling node; and
return deployment success indication information to the scheduling node when the registration succeeds, the deployment success indication information carrying the digital certificate.

The apparatus may be configured to perform the method performed by the verification node in the embodiments of this application. Therefore, for the functions that can be implemented by functional modules of the apparatus, reference may be made to the description of the foregoing embodiments. Details are not described herein again.

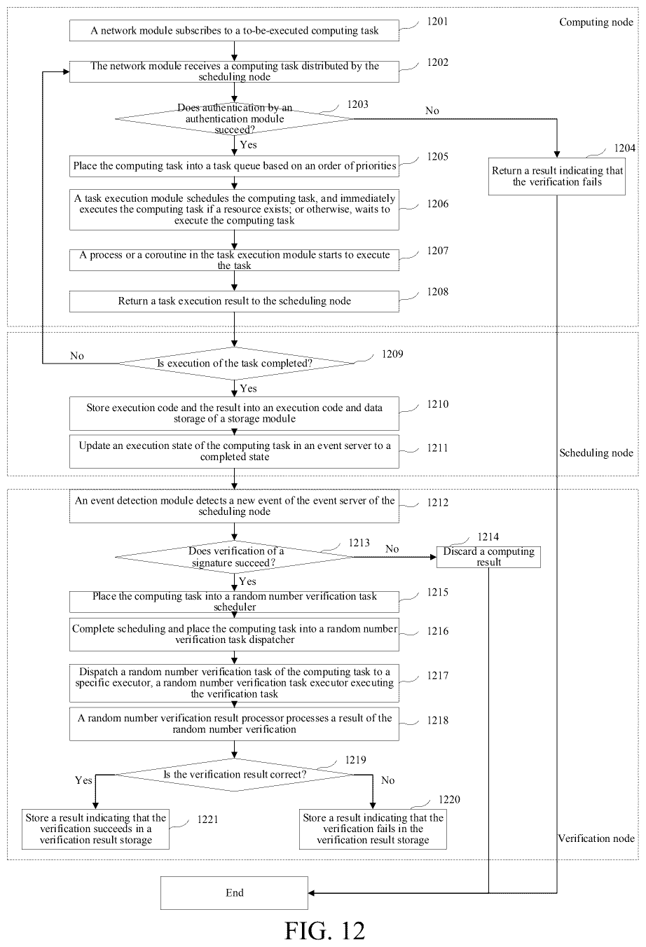

As shown in FIG. 14, based on the same inventive concept, an embodiment of this application further provides a data processing apparatus 140, which is applied to any scheduling node in a scheduling node cluster included in a computing system, and the computing system further includes a verification node cluster and a computing node cluster. The apparatus includes:
a task receiving unit 1401, configured to receive a computing request transmitted by a task submission end, the computing request including: a computing task and a random seed provided for the computing task;
a node selection unit 1402, configured to: derive a second random number set based on the random seed; select, for the computing task, a first computing node set associated with the second random number set from the computing node cluster; and dispatch the computing task to the first computing node set, so that the first computing node set executes the computing task;
an event updating unit 1403, configured to update the computing task to a completed state when a computing result of each first computing node in the first computing node set for the computing task is received;
an event notification unit 1404, configured to: generate task event information and a signature for the task event information, the task event information including the first computing node set participating in execution of the computing task and a random seed provided by the task submission end of the computing task; and transmit the task event information and the signature for the task event information to a verification node connected to the scheduling node, so that the verification node verifies validity of the first computing node set.

In a possible implementation, the apparatus further includes a node deployment unit 1405, which is configured to:
receive a computing node deployment request, the computing node deployment request carrying identity information of a to-be-deployed computing device (also referred to as a “target computing device”) and resource configuration information;
determine whether the computing device satisfies a configuration need of the computing node based on the resource configuration information if validity verification of the identity information succeeds;
add the computing device to the computing node cluster if the computing device satisfies the configuration need, and updating a node state table through the computing device, the node state table being configured for storing a node state of each computing node connected to the computing device; and
issue a digital certificate to the computing device, and return deployment success indication information to the computing device, the deployment success indication information carrying the digital certificate.

The apparatus may be configured to perform the method performed by the scheduling node in the embodiments of this application. Therefore, for the functions that can be implemented by functional modules of the apparatus, reference may be made to the description of the foregoing embodiments. Details are not described herein again.

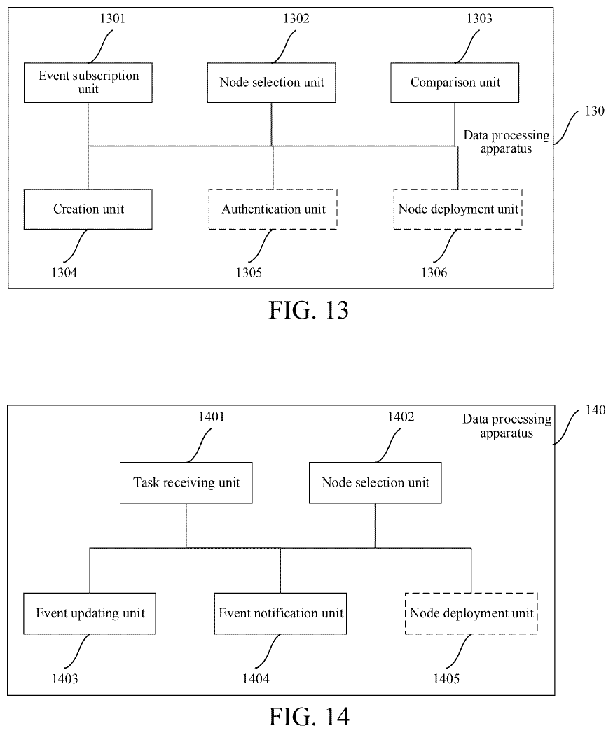

As shown in FIG. 15, based on the same inventive concept, an embodiment of this application further provides a data processing apparatus 150, which is applied to any computing node in a computing node cluster included in a computing system, and the computing system further includes a verification node cluster and a scheduling node cluster. The apparatus includes:
a task receiving unit 1501, configured to:
receive a computing request transmitted by a scheduling node connected to the computing node, the computing request instructing to: execute a computing task submitted by a task submission end;
a task execution unit 1502, configured to execute the computing task to obtain a corresponding computing result, and sign the computing result based on a digital certificate of the computing task to obtain corresponding signature information; and
a result transmission unit 1503, configured to transmit the computing result and the signature information to the scheduling node, to cause the scheduling node to: update the computing task to a completed state when a computing result for the computing task by each first computing node in the first computing node set participating in the execution of the computing task is received; generate task event information and a signature for the task event information, the task event information including the first computing node set and a random seed provided by the task submission end of the computing task; and transmit the task event information and the signature for the task event information to a verification node connected to the scheduling node, so that the verification node verifies validity of the first computing node set.

The apparatus may be configured to perform the method performed by the computing node in the embodiments of this application. Therefore, for the functions that can be implemented by functional modules of the apparatus, reference may be made to the description of the foregoing embodiments. Details are not described herein again.

Through the foregoing apparatus, infinite scalability of multi-party computation can be ensured. Each user may access a computer thereof to a nearest scheduling node, and provide a specific computing power as the computing node. A user needing computation may transmit a computing task to a designated scheduling node, and randomly select a computing node based on a random seed transmitted by the user, thereby ensuring fairness and security of the computing task. Finally, identities of all nodes can be ensured to be trustworthy through a plurality of certificate authority mechanisms.

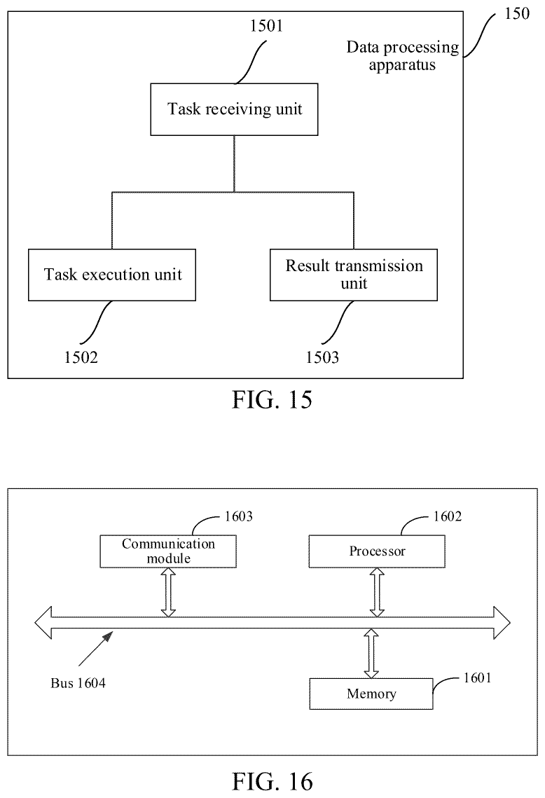

As shown in FIG. 16, based on the same technical concept, an embodiment of this application further provides a computer device. In an embodiment, the computer device may be the verification node, the scheduling node, or the computing node above. As shown in FIG. 16, the computer device includes a memory 1601, a communication module 1603, and one or more processors 1602.

The memory 1601 is configured to store a computer program executed by the processor 1602. The memory 1601 may mainly include a program storage area and a data storage area. The program storage area may store an operating system and a program needed for running the foregoing functions; and the data storage area may store various instant communication information, an operation instruction set, and the like.

The memory 1601 may be a volatile memory, for example, a random-access memory (RAM); the memory 1601 may also be a non-volatile memory, for example, a read-only memory, a flash memory, a hard disk drive (HDD), or a solid-state drive (SSD). Alternatively, the memory 1601 is any other medium that can be configured to carry or store desired program code in the form of instructions or data structures and can be accessed by a computer, which is not limited thereto. The memory 1601 may be a combination of the foregoing memories.

The processor 1602 may include one or more CPUs, a digital processing unit, or the like. The processor 1602 is configured to implement the foregoing data processing method when invoking the computer program stored in the memory 1601.

The communication module 1603 is configured to communicate with a terminal device and another node.

Specific connection media among the memory 1601, the communication module 1603, and the processor 1602 above are not limited in the embodiments of this application. In the embodiments of this application, in FIG. 16, the memory 1601 and the processor 1602 are connected through a bus 1604. The bus 1604 is depicted by a bold line in FIG. 16. A manner of connection between other components is merely an example for description, and this application is not limited thereto. The bus 1604 may be divided into an address bus, a data bus, a control bus, and the like. For ease of representation, only one bold line is configured to represent the bus in FIG. 16, but this does not mean that only one bus or only one type of bus exists.

The memory 1601 has a computer storage medium stored therein. The computer storage medium has a computer-executable instruction stored therein. The computer-executable instruction is configured to implement the data processing method in the embodiments of this application. The processor 1602 is configured to perform the data processing methods in the foregoing embodiments.

Based on the same inventive concept, an embodiment of this application further provides a storage medium. The storage medium has a computer program stored therein. The computer program, when run on a computer, causes the computer to perform the operations in the data processing method according to various exemplary implementations of this application described above in the specification.

In some possible implementations, various aspects of the data processing method provided in this application may further be implemented in the form of a computer program product. The computer program product includes a computer program. When the program product is run on a computer device, the computer program is configured for causing the computer device to perform the operations in the data processing method according to various exemplary implementations of this application described above in the specification. For example, the computer device may perform the operations in the embodiments.

The program product may be any combination of one or more readable media. The readable medium may be a readable signal medium or a readable storage medium. The readable storage medium may be, for example, but is not limited to, an electric, magnetic, optical, electromagnetic, infrared, or semi-conductive system, apparatus, or device, or any combination thereof. More specific examples (a non-exhaustive list) of the readable storage medium include: an electrical connection by one or more wires, a portable computer disk, a hard disk, a RAM, a ROM, an erasable programmable ROM (EPROM or a flash memory), an optical fiber, a portable compact disk read-only memory (CD-ROM), an optical memory device, a magnetic storage device, or any appropriate combination thereof.

The program product of the implementation of this application may be a CD-ROM and include a computer program, and may be run on a computer device. However, the program product in this application is not limited thereto. In this specification, the readable storage medium may be any tangible medium including or storing a program, and the computer program may be used by or used in combination with a command execution system, an apparatus, or a device.

The readable signal medium may include a data signal being in a baseband or transmitted as a part of a carrier, which carries a readable computer program. A data signal propagated in such a way may assume multiple forms, including, but not limited to, an electromagnetic signal, an optical signal, or any appropriate combination thereof. The readable storage medium may alternatively be any readable medium other than a readable storage medium, and the readable storage medium may be configured to send, propagate, or transmit a program used by or in combination with a command execution system, an apparatus, or a device.

The computer program included in the readable medium may be transmitted by using any suitable medium, including but not limited to a wireless medium, a wired medium, an optical cable, an RF, or the like, or any suitable combination thereof.

The computer program configured to perform the operations of this application may be written in any combination of one or more programming languages. The programming languages include object-oriented programming languages such as Java and C++, and further include conventional procedural programming languages such as a “C” language or similar programming languages.

Although several units or subunits of the apparatus are mentioned in the foregoing detailed descriptions, such division is merely exemplary and not mandatory. Actually, based on the implementations of this application, features and functions of two or more units described above may be specified in one unit. On the contrary, the features or the functions of one unit described above may further be divided and specified by a plurality of units.

In the embodiments of this application, a term “module” or “unit” refers to a computer program or a part of the computer program that has a predetermined function and operates together with another relevant part to achieve a predetermined goal, and may be entirely or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

In addition, although the operations of the method in this application are described in a specific order in the accompanying drawings, this does not require or imply that the operations are bound to be performed in the specific order, or all the operations shown are bound to be performed to achieve the desired result. Additionally or alternatively, some operations may be omitted, a plurality of operations may be combined into one operation for execution, and/or one operation may be decomposed into a plurality of operations for execution.

A person skilled in the art can understand that the embodiments of this application may be provided as a method, a system, or a computer program product. Therefore, this application may use a form of hardware-only embodiments, software-only embodiments, or embodiments combining software and hardware. In addition, this application may use a form of a computer program product that is implemented on one or more computer-usable storage media (including but not limited to a disk memory, a CD-ROM, an optical memory, and the like) that include computer-usable program code.

Although exemplary embodiments of this application have been described, additional changes and modifications to these embodiments may be made by a person skilled in the art once the basic creative concept is apparent. Therefore, the appended claims are intended to be interpreted as including some embodiments and all changes and modifications falling within the scope of embodiments of this application.

Apparently, a person skilled in the art may make various modifications and variations to this application without departing from the spirit and scope of this application. In this way, if the modifications and variations made to this application fall within the scope of the claims of this application and their equivalent technologies, this application is also intended to include these modifications and variations.

What is claimed is:

1. A data processing method, performed on a verification node in a verification node cluster of a computing system, comprising:
obtaining task event information and a signature for the task event information from a scheduling node in a scheduling node cluster of the computing system, the task event information including a first computing node set participating in execution of a computing task and a random seed provided by a task submission end of the computing task;
performing verification on the signature;
deriving a random number set based on the random seed in response to the verification of the signature succeeds;
selecting, for the computing task, a second computing node set associated with the random number set from a computing node cluster of the computing system;
verifying validity of the first computing node set by using the second computing node set, to obtain a verification result; and
adding a block including the verification result to a blockchain of the verification node cluster.

2. The method according to claim 1, wherein:
each verification node in the verification node cluster is connected to at least one scheduling node in the scheduling node cluster, and each scheduling node is uniquely connected to one verification node;
each scheduling node in the scheduling node cluster is connected to at least one computing node in the computing node cluster, and each computing node is uniquely connected to one scheduling node; or
the scheduling node cluster includes a plurality of scheduling node sub-clusters each including N levels of scheduling nodes, with N being a positive integer greater than 1, a first level of scheduling node of the N levels of scheduling nodes being connected to a next level of scheduling node, a last level of scheduling node being connected to at least one computing node and being connected to a previous level of scheduling node, and an i^{th} level of scheduling node being connected to an (i−1)^{th} level of scheduling node and an (i+1)^{th} level of scheduling node, i being a positive integer greater than 1 and less than N.

3. The method according to claim 1, wherein selecting the second computing node set includes:
selecting a candidate computing node set from the computing node cluster;
determining, for various candidate computing nodes in the candidate computing node set, random number ranges corresponding to the various candidate computing nodes, respectively, based on evaluation values of the various candidate computing nodes each representing an availability degree of a computing resource, the random number ranges corresponding to the various candidate computing nodes not overlapping with each other; and
for a random number in the random number set, adding a candidate computing node corresponding to a random number range in which the random number is located to the second computing node set.

4. The method according to claim 3, wherein selecting the candidate computing node set includes:
selecting the candidate computing node set from a plurality of computing nodes in the computing node cluster that are connected to the scheduling node.

5. The method according to claim 3, wherein deriving the random number set includes:
performing K rounds of iterative selection processes by using the random seed as an initial value of a random number selection factor, to obtain the random number set, K being a quantity of computing nodes needed for the computing task, and each round of selection process including:
obtaining a random number corresponding to a current round based on an evaluation value sum of the candidate computing node set and a random number selection factor used in the current round; and
updating the random number selection factor used in the current round, to obtain a random number selection factor to be used in a next round.

6. The method according to claim 5, wherein obtaining the random number corresponding to the current round includes:
obtaining a remainder of dividing the random number selection factor used in the current round by the evaluation value sum, the remainder being the random number corresponding to the current round.

7. The method according to claim 5, wherein updating the random number selection factor used in the current round includes:
performing hash value mapping on a (c−x)^{th} block in the blockchain, to obtain a hash value, c being a serial number of a latest block in the blockchain, and x being a quantity of rounds of the iterative selection process; and
updating the random number selection factor used in the current round based on the hash value, to obtain the random number selection factor to be used in the next round.

8. The method according to claim 1, wherein performing verification on the signature includes:
decrypting the signature through a public key of the scheduling node, to obtain first digest information of the task event information generated by the scheduling node;
performing digest extraction on the task event information to obtain second digest information; and
determining whether the verification of the signature succeeds based on the first digest information and the second digest information.

9. The method according to claim 1, further comprising:
receiving a scheduling node deployment request, the scheduling node deployment request carrying identity information of a target scheduling node and interface information of an event notification interface;
performing an interface connectivity test on the target scheduling node based on the interface information in response to success of validity verification of the identity information;
adding the target scheduling node to the scheduling node cluster and issuing a digital certificate to the target scheduling node in response to success of the interface connectivity test;
transmitting a registration request for the event notification interface to the target scheduling node in response to success of consensus verification performed by the verification node cluster on a digital certificate issuance result of the target scheduling node, the registration request being configured for subscribing to a target type event from the target scheduling node; and
returning deployment success indication information to the target scheduling node in response to success of registration for the event notification interface, the deployment success indication information carrying the digital certificate.

10. A computer device comprising:
a memory storing a computer program; and
a processor configured to execute the computer program to implement the method according to claim 1.

11. The computer device according to claim 10, wherein:
each verification node in the verification node cluster is connected to at least one scheduling node in the scheduling node cluster, and each scheduling node is uniquely connected to one verification node;
each scheduling node in the scheduling node cluster is connected to at least one computing node in the computing node cluster, and each computing node is uniquely connected to one scheduling node; or
the scheduling node cluster includes a plurality of scheduling node sub-clusters each including N levels of scheduling nodes, with N being a positive integer greater than 1, a first level of scheduling node of the N levels of scheduling nodes being connected to a next level of scheduling node, a last level of scheduling node being connected to at least one computing node and being connected to a previous level of scheduling node, and an i^{th} level of scheduling node being connected to an (i−1)^{th} level of scheduling node and an (i+1)^{th} level of scheduling node, i being a positive integer greater than 1 and less than N.

12. The computer device according to claim 10, wherein selecting the second computing node set includes:
selecting a candidate computing node set from the computing node cluster;
determining, for various candidate computing nodes in the candidate computing node set, random number ranges corresponding to the various candidate computing nodes, respectively, based on evaluation values of the various candidate computing nodes each representing an availability degree of a computing resource, the random number ranges corresponding to the various candidate computing nodes not overlapping with each other; and
for a random number in the random number set, adding a candidate computing node corresponding to a random number range in which the random number is located to the second computing node set.

13. A non-transitory computer-readable storage medium storing a computer program that, when executed by a processor, causes the processor to implement the method according to claim 1.

14. A data processing method, performed on a scheduling node in a scheduling node cluster of a computing system, comprising:
receiving a computing request transmitted by a task submission end, the computing request including a computing task and a random seed provided for the computing task;
deriving a random number set based on the random seed;
selecting, for the computing task, a computing node set associated with the random number set from a computing node cluster of the computing system;
dispatching the computing task to the computing node set, so that the computing node set executes the computing task;
updating the computing task to a completed state in response to receiving a computing result of each computing node in the computing node set for the computing task;
generating task event information and a signature for the task event information, the task event information including the computing node set and the random seed; and
transmitting the task event information and the signature for the task event information to a verification node, connected to the scheduling node, in a verification node cluster of the computing system, so that the verification node verifies validity of the computing node set.

15. The method according to claim 14, further comprising:
receiving a computing node deployment request, the computing node deployment request carrying identity information of a target computing device and resource configuration information;
determining whether the target computing device satisfies a configuration need of the computing node based on the resource configuration information in response to success of validity verification of the identity information;
adding the computing device to the computing node cluster in response to the computing device satisfying the configuration need, and updating a node state table through the computing device, the node state table being configured for storing a node state of each computing node connected to the target computing device; and
issuing a digital certificate to the target computing device, and returning deployment success indication information to the target computing device, the deployment success indication information carrying the digital certificate.

16. A computer device comprising:
a memory storing a computer program; and
a processor configured to execute the computer program to implement the method according to claim 14.

17. A non-transitory computer-readable storage medium storing a computer program that, when executed by a processor, causes the processor to implement the method according to claim 14.

18. A data processing method, performed on a computing node in a computing node cluster of a computing system, comprising:
receiving a computing request transmitted by a scheduling node connected to the computing node, the computing request instructing to execute a computing task submitted by a task submission end;
executing the computing task to obtain a computing result, and signing the computing result based on a digital certificate of the computing task to obtain signature information; and
transmitting the computing result and the signature information to the scheduling node, to cause the scheduling node to:
update the computing task to a completed state in response to a computing result for the computing task by each computing node in a computing node set participating in the execution of the computing task is received;
generate task event information and a signature for the task event information, the task event information including the computing node set and a random seed provided by the task submission end; and
transmit the task event information and the signature for the task event information to a verification node, connected to the scheduling node, in a verification node cluster of the computing system, so that the verification node verifies validity of the computing node set.

19. A computer device comprising:
a memory storing a computer program; and
a processor configured to execute the computer program to implement the method according to claim 18.

20. A non-transitory computer-readable storage medium storing a computer program that, when executed by a processor, causes the processor to implement the method according to claim 18.
